(19) United States
(12) Patent Application Publication
(10) Pub. No.: US 2020/0410376 A1
(43) Pub. Date: Dec. 31, 2020

(54) PREDICTION METHOD, TRAINING METHOD, APPARATUS, AND COMPUTER STORAGE MEDIUM

(71) Applicant: HUAWEI TECHNOLOGIES CO., LTD., Shenzhen (CN)

(72) Inventors: Min ZHOU, Shenzhen (CN); Wensen YANG, Shenzhen (CN); Jianfeng ZHANG, Boulogne Billancourt (FR)

(21) Appl. No.: 17/020,361

(22) Filed: Sep. 14, 2020

Related U.S. Application Data
(63) Continuation of application No. PCT/CN2019/087185, filed on May 16, 2019.

(30) Foreign Application Priority Data
May 18, 2018 (CN) 201810481548.0

(51) Int. Cl. G06N 5/04; G06N 20/00

(52) U.S. Cl. CPC G06N 5/04; G06N 20/00

(57) ABSTRACT

A method of modeling a numerical relationship between a user quantity indicator and a resource usage indicator includes performing first regression on a first dataset that describes a numerical relationship between a feature of the user quantity indicator and a feature of a service usage indicator, to obtain a first prediction model. The method further includes performing second regression on a second dataset that describes a numerical relationship between the feature of the service usage indicator and a feature of the resource usage indicator, to obtain a second prediction model.

### CROSS-REFERENCE TO RELATED APPLICATIONS

This application is a continuation of International Application No. PCT/CN2019/087185, filed on May 16, 2019, which claims priority to Chinese Patent Application No. 201810481548.0 filed on May 18, 2018. The disclosures of the aforementioned applications are hereby incorporated by reference in their entireties.

### TECHNICAL FIELD

This application relates to the communications field, and more specifically, to a method, an apparatus, and a non-transitory computer storage medium for resource usage modeling.

### BACKGROUND

In a model training process, training data of a device may be obtained, and a prediction model may be obtained based on the training data. In a prediction process, some future cases may be predicted based on the obtained prediction model and an actual situation.

In other approaches, in the model training process, two pieces of training data of a network device may be directly obtained, and the prediction model may be directly obtained through training based on the two pieces of training data.

For example, before carrying out a service activity, a communications network operator needs to predict future resource usage (also referred to as a resource usage indicator) of a communications device based on an assumed value of a quantity of users that use a service (also referred to as a user quantity indicator), and may pre-expand a network device that may be overloaded, to ensure stable running of a system.

In other approaches, a function relationship between a user quantity indicator and a resource usage indicator of a target device is directly trained, and resource usage is predicted based on an assumed user quantity and the function relationship between the user quantity and the resource usage. During a data sample collection period, the user quantity indicator of the target device may not change greatly, resulting in absence of diversity of sample data. Because a relationship between the user quantity and the resource usage is not fully reflected in the data, it is quite difficult to obtain an accurate function relationship between the user quantity and the resource usage. In addition, it is difficult to implement large-range extrapolative prediction based on the predicted function relationship.

Therefore, when diversity of a collected training data sample is insufficient, how to obtain an accurate prediction model by using two pieces of training data and accurately predict one piece of data based on the other piece of prediction data becomes an urgent problem to be resolved.

### SUMMARY

This application provides a prediction method, a training method, an apparatus, and a computer storage medium, so that an accurate prediction model can be obtained by using two pieces of training data, where one piece of data may be accurately predicted based on the other piece of prediction data.

According to a first aspect, a prediction method is provided, including: obtaining to-be-predicted first indicator data of a target device; inputting the to-be-predicted first indicator data into a first prediction model, to obtain predicted second indicator data of the target device; and inputting the predicted second indicator data into a second prediction model, to obtain a prediction result of the target device.

In at least one embodiment, the first prediction model may be obtained through training based on first training data, and the second prediction model may be obtained through training based on second training data.

In at least one embodiment, the first training data may include first indicator data and second indicator data that are of a plurality of network devices. In other words, the first indicator data and the second indicator data may be from the plurality of network devices including the target device.

In at least one embodiment, the first indicator data and the second indicator data are not specifically limited, and may be any two pieces of indicator data.

In some embodiments, the first indicator data may be a user quantity, and the second indicator data may be a traffic volume.

The second training data may include the second indicator data and third indicator data that are of the target device.

In at least one embodiment, the first indicator data and the second indicator data may be from the target device.

In at least one embodiment, the second indicator data and the third indicator data are not specifically limited, and may be any two pieces of indicator data.

In some embodiments, the second indicator data may be the traffic volume, and the third indicator data may be a resource usage.

The target device and/or a network device (also referred to as a communications network device) mentioned in are/is not specifically limited, and may include but be not limited to any subnet, a network element, a sub-device (for example, a board) of a network element, and a functional unit (for example, a module) of a network element. For example, the communications network device may include but is not limited to a network adapter, a network transceiver, a network media conversion device, a multiplexer, an interrupter, a hub, a bridge, a switch, a router, a gateway, and the like.

The following provides detailed descriptions by using an example in which the first indicator data is the user quantity and the second indicator data is the traffic volume.

The user quantity indicator in at least one embodiment may be represented as a quantity of users that use a service on a communications network device.

In at least one embodiment, there may be a plurality of user quantity indicators for one communications network device. In an example, the user quantity may be represented as an indicator “2G+3G user quantity”. In another example, the user quantity may be represented as an indicator “4G user quantity”. In another example, the user quantity may be represented as an indicator “registered-user quantity”. This is not specifically limited in at least one embodiment.

In at least one embodiment, the traffic volume indicator may be understood as a quantity of users that use a service on a communications network device.

In at least one embodiment, there may be a plurality of traffic volume indicators of one device. In an example, the traffic volume of the communications network device may be represented as an indicator “total traffic volume usage” of the network device. In another example, the traffic volume of the communications network device may be represented as an indicator “Gi interface packet quantity” of the network device. In another example, the traffic volume of the communications network device may be represented as an indicator “SGi user-plane packet quantity” of the network device. This is not specifically limited in at least one embodiment.

In at least one embodiment, In at least one embodiment, in at least one embodiment, the resource usage indicator may be represented as a resource consumption of a communications network device.

In at least one embodiment, different devices may have different resource usage indicators. In an example, the resource usage indicator may be represented as an indicator “CPU peak usage”. In another example, the resource usage indicator may be represented as an indicator “memory usage”. In another example, the resource usage indicator may be represented as an indicator “license usage”. This is not specifically limited in at least one embodiment.

In at least one embodiment, the plurality of network devices may be network devices, where the plurality of network devices and the target device have a consistent indicator relationship between the user quantity indicator and the traffic volume indicator.

In at least one embodiment, another network device and the target device have a same or basically same change tendency in the indicator relationship between the user quantity indicator and the traffic volume indicator.

If the another network device and the target device have a consistent indicator relationship between the user quantity indicator and the traffic volume indicator, the user quantity indicator and the traffic volume indicator of a plurality of network devices (including the target device and the another network device) may be collected, so that diversity of a data sample of the user quantity indicator can be increased. Because the another network device and the target device have the same or basically same change tendency in the indicator relationship between the user quantity indicator and the traffic volume indicator, the collected user quantity indicators and the collected traffic volume indicators of the plurality of network devices (including the target device and the another network device) are trained, and an obtained prediction model is applicable to the target device and the another network device. The prediction model obtained through training may be used to accurately predict a predicted resource usage of the target device and the another network device.

For example, network elements ATS 0 and ATS 1 are communications devices of a same type. The communications device may have a hierarchical decomposition structure. The network element ATS 0 may be decomposed into modules: a VCU 0, a VCU 1, and a DPU 0 (Services of the network element ATS 0 may be evenly loaded among the three modules (the VCU 0, the VCU 1, and the DPU 0) of the network element ATS 0). The network element ATS 1 may be decomposed into modules: a VCU 0, a VCU 1, and a DPU 0 (Services of the network element ATS 1 may be evenly loaded among the three modules (the VCU 0, the VCU 1, and the DPU 0) of the ATS 1). The user quantity indicator (for example, an indicator “registered-user quantity”) may correspond to network elements (the ATS 0 and the ATS 1), and the traffic volume indicator (for example, an indicator “total traffic volume usage”) may correspond to the network elements (the ATS 0 and the ATS 1), and the resource usage indicator (for example, an indicator “CPU peak usage”) may correspond to modules (the VCU 0, the VCU 1, and the DPU 0) of the network elements (the ATS 0 and the ATS 1). The ATS 0 and the ATS 1 are communications device of a same type. The indicator “registered-user quantity” and the indicator “total traffic volume usage” both correspond to the network elements, and a definition of the indicator “registered-user quantity” and a definition of the indicator “total traffic volume usage” of the network element ATS 0 are respectively the same as a definition of the indicator “registered-user quantity” and a definition of the indicator “total traffic volume usage” of the network element ATS 1. Therefore, a correlation between the indicator “registered-user quantity” and the indicator “total traffic volume usage” has cross-device combination generalization between the network element ATS 0 and the network element ATS 1. (The network element ATS 0 and the network element ATS 1 have a consistent indicator relationship between the user quantity indicator and the traffic volume indicator.)

In the foregoing solution, the first prediction model may be obtained through training by using the collected first training data of the plurality of devices (including the target device and the another network device), so that diversity of historical data samples of the first indicator data can be increased. Then, the second prediction model may be obtained through training by using the collected second training data of the target device, so that a function relationship between the first indicator data and the second indicator data can be more accurately reflected.

With reference to the first aspect, in a possible implementation, the method further includes: obtaining the first training data; and obtaining the first prediction model based on the first training data.

In at least one embodiment, the first prediction model is used to predict the second indicator data of the target device based on the first indicator data of the target device.

An implementation of obtaining the first prediction model through training based on the first training data is not specifically limited in at least one embodiment. In an example, regression may be performed on the first training data to obtain the first prediction model. In another example, regression through an origin may be performed on the first training data to obtain the first prediction model.

An implementation of obtaining the second prediction model through training based on the second training data is not specifically limited in at least one embodiment. In an example, regression may be performed on the second training data to obtain the second prediction model. In another example, regression through an origin may be performed on the second training data to obtain the second prediction model. In another example, quantile regression may be performed on the second training data to obtain the second prediction model.

In at least one embodiment, feature processing may be performed on indicator data before regression is performed on the first indicator data, the second indicator data, and the third indicator data (for example, the user quantity indicator, the traffic volume indicator, and the resource usage indicator). In an example, standardization (standardization) processing may be performed on the indicator data. In another example, normalization (normalization) processing may be performed on the indicator data. In another example, dimension reduction processing may be performed on the indicator data.

In the foregoing technical solution, the to-be-predicted first indicator data may be input into the first prediction model, to obtain the prediction result of the target device.

With reference to the first aspect, in a possible implementation, principal component analysis is performed on the first indicator data in the first training data, to obtain a principal component analysis model; dimension reduction processing is performed on the first training data based on the principal component analysis model, to obtain dimension-reduced third training data; and the first prediction model is trained based on the third training data.

In at least one embodiment, there are a plurality of manners of performing dimension reduction on the first training data. This is not specifically limited in. In an example, principal component analysis may be performed on the first training data. For example, principal component analysis may be performed on the second indicator data in the first training data, to obtain a principal component analysis model; and dimension reduction processing may be performed on the first training data based on the principal component analysis model, to obtain dimension-reduced third training data. In another example, low variance filter (low variance filter) processing may be performed on the first training data, so that performing dimension reduction processing on the first training data can be implemented. In another example, backward feature elimination (backward feature elimination) processing may be performed on the first training data, so that performing dimension reduction processing on the first training data can be implemented.

In at least one embodiment, the principal component analysis processing method may be a statistical method. A group of second indicator data that may have a correlation with each other may be converted into a group of linearly-unrelated variables through orthogonal transformation. The converted variables may be referred to as principal components of the second indicator data.

In the foregoing technical solution, dimension reduction is performed on the first indicator data, to avoid calculation difficulty that may be caused due to collinearity of the first indicator data and that may be encountered when regression is performed on the second training data.

With reference to the first aspect, in a possible implementation, regression is performed on the first training data to obtain the first prediction model.

In at least one embodiment, there are many methods for obtaining the first prediction model through training based on the first training data. This is not specifically limited in. In an example, regression may be performed on the first training data to obtain the first prediction model. In another example, regression through an origin may be performed on the first training data to obtain the first prediction model.

In the foregoing technical solution, the first prediction model may be obtained through training by using the regression method, so that degrees of correlation and fitting between factors can be accurately calculated and measured. This manner is characterized by simple calculation and easy implementation.

With reference to the first aspect, in a possible implementation, when diversity of the first training data meets a preset condition, regression through an origin is performed on the first training data; or when diversity of the first training data does not meet the preset condition, regression not through an origin is performed on the first training data.

In at least one embodiment, data diversity of the first indicator data may be determined. If data diversity of the first indicator data in the first training data does not meet the preset condition, constrained regression through an origin may be performed on the first indicator data and the second indicator data in the first training data. If data diversity of the first indicator data in the first training data meets the preset condition, unconstrained regression through an origin may be performed on the first indicator data and the second indicator data in the first training data.

In at least one embodiment, the preset condition mentioned above may be a preset threshold. If data diversity of the first indicator data reaches the preset threshold, it may indicate that data diversity of the first indicator data meets the preset condition.

In at least one embodiment, both regression through an origin and regression not through an origin performed on data may be considered as regression performed on the data. A model obtained through constrained regression through an origin may not include a constant term, and a model obtained through unconstrained regression through an origin may include a constant term.

In some embodiments, some feature processing may be performed on the first indicator data before diversity determining is performed on the first indicator data. This is not specifically limited in. In an example, normalization (Normalization) processing may be performed on the first indicator data, and data diversity determining may be performed on normalization-processed first indicator data. In another example, standardization (Standardization) processing may be performed on the first indicator data, and data diversity determining may be performed on standardization-processed first indicator data. In another example, dimension reduction processing may be performed on the first indicator data, and data diversity determining may be performed on dimension-reduction-processed first indicator data.

In the foregoing technical solution, when diversity of the first indicator data in the first training data does not meet the preset condition, constrained regression through an origin may be performed on the first indicator data and the second indicator data, so that model extrapolation is inaccurate due to insufficient diversity of the first indicator data in a dataset is avoided. When diversity of the first indicator data in the first training data meets the preset condition, unconstrained regression through an origin may be performed, to fully use information provided in a dataset, so as to obtain a more accurate model.

With reference to the first aspect, in a possible implementation, regression is performed on the second training data to obtain the second prediction model.

In at least one embodiment, regression through an origin may be performed on the second training data to obtain the second prediction model through training. Alternatively, regression not through an origin may be performed on the second training data to obtain the second prediction model through training. This is not specifically limited in.

For a specific method for performing regression on the second training data, refer to the description of the first training data. Details are not described herein again.

With reference to the first aspect, in a possible implementation, quantile regression is performed on the second training data to obtain the second prediction model.

In at least one embodiment, quantile regression may be one of regression methods. A quantile may be a numerical value point used to divide a distribution range of a random variable according to a probability ratio. Quantile regression may be used to predict an upper bound or a lower bound of an indicator. In an example, a quantile parameter 0.1 may be used to indicate that a distribution range of a variable is divided into two parts, and a probability that the variable is less than the quantile 0.1 may be 0.1. For example, if a lower bound of the resource usage indicator needs to be predicted, a smaller quantile value 0.1 or 0.2 may be selected.

A method for performing quantile regression on the second indicator data and the third indicator data in the second training data is not specifically limited in at least one embodiment. In an example, a linear quantile regression method may be used. In another example, a non-linear quantile regression method may be used.

In the foregoing technical solution, the second prediction model is established through quantile regression, and can be used to predict an upper bound and a lower bound, rather than an average value, of the third indicator data, to meet a concern of an application requirement for a boundary value.

According to a second aspect, a training method is provided, including: obtaining first training data and second training data; obtaining a first prediction model based on first training data; and obtaining a second prediction model based on the second training data.

In some embodiments, the first indicator data may be first indicator data, the second indicator data may be second indicator data, and the third indicator data may be third indicator data.

With reference to the second aspect, in a possible implementation, to-be-predicted first indicator data of a target device is obtained; the to-be-predicted first indicator data is input into the first prediction model, to obtain predicted second indicator data of the target device; and the predicted second indicator data is input into the second prediction model, to obtain a prediction result of the target device.

For a specific method for training the first prediction model, refer to the description of the prediction method in the first aspect. Details are not described herein again.

With reference to the second aspect, in a possible implementation, principal component analysis is performed on the second indicator data in the first training data, to obtain a principal component analysis model; dimension reduction processing is performed on the first training data based on the principal component analysis model, to obtain dimension-reduced third training data; and the first prediction model is trained based on the third training data.

With reference to the second aspect, in a possible implementation, regression is performed on the first training data to obtain the first prediction model.

With reference to the second aspect, in a possible implementation, when diversity of the first training data meets a preset condition, regression through an origin is performed on the first training data; or when diversity of the first training data does not meet the preset condition, regression not through an origin is performed on the first training data.

With reference to the second aspect, in a possible implementation, second training data of the target device is obtained; and the second prediction model of the target device is trained based on the second training data.

In at least one embodiment, before predicted third indicator data is obtained based on the predicted first indicator data indicator based on the first prediction model and the second prediction model, the second prediction model may be obtained through training based on the obtained second training data.

For a specific method for training the second prediction model, refer to the description of the prediction method in the first aspect. Details are not described herein again.

With reference to the second aspect, in a possible implementation, regression is performed on the second training data to obtain the second prediction model.

With reference to the second aspect, in a possible implementation, quantile regression is performed on the second training data to obtain the second prediction model.

With reference to the second aspect, in a possible implementation, the target device and another network device have a consistent indicator relationship between the first indicator data indicator and the second indicator data indicator.

In other words, if a plurality of devices have a consistent indicator relationship between the first indicator data and the second indicator data, first indicator data and second indicator data of the plurality of devices may be obtained, and a prediction model obtained by training the first indicator data and the second indicator data of the plurality of devices is applicable to a plurality of devices.

According to a third aspect, a method for modeling a numerical relationship between a user quantity indicator and a resource usage indicator is provided, including: performing first regression on a first dataset that describes a numerical relationship between a feature of a user quantity indicator and a feature of a service usage indicator, to obtain a first prediction model; and performing second regression on a second dataset that describes a numerical relationship between the feature of the service usage indicator and a feature of a resource usage indicator, to obtain a second prediction model. Any data sample in the first dataset corresponds to values of the user quantity indicator and values of the service usage indicator of a device combination under a condition. Original values of the user quantity indicator of some devices in the device combination are directly used as a feature of the user quantity indicator in the data sample or are input for first feature processing, and an output value of the first feature processing is used as a feature of the user quantity indicator in the data sample. Original values of the service usage indicator of some devices in the device combination are directly used as the feature of the service usage indicator in the data sample or are input for second feature processing, and an output value of the second feature processing is used as the feature of the service usage indicator in the data sample.

In the first dataset, all data samples correspond to more than one set that includes a device combination. There is at least one pair of data samples in the dataset, there is at least one user quantity indicator, and original values of the user quantity indicator in the pair of data samples are obtained from two different devices.

Any data sample in the second dataset corresponds to the values of the service usage indicator and values of the resource usage indicator of a device combination under a condition. Original values of the service usage indicator of some devices in the device combination are directly used as the feature of the service usage indicator in the data sample or are input for second feature processing, and an output value of the second feature processing is used as the feature of the service usage indicator in the data sample. Original values of the resource usage indicator of some devices in the device combination are directly used as the feature of the resource usage indicator in the data sample or are input for third feature processing, and an output value of the third feature processing is used as the feature of the resource usage indicator in the data sample.

With reference to the third aspect, in a possible implementation, the service usage indicator is determined based on the user quantity indicator and the service usage indicator.

With reference to the third aspect, in a possible implementation, in the first dataset, different data samples have similar load distribution relationships between a device that provides the original value of the user quantity indicator and a device that provides the original value of the service usage indicator.

With reference to the third aspect, in a possible implementation, when input values are all zeros or approximately all zeros in the second feature processing, output values are all zeros or approximately all zeros.

With reference to the third aspect, in a possible implementation, the second feature processing includes a first translation transformation, and the first translation transformation is determined by performing the following steps:

performing partial processing of the second feature processing on the input values that are all zeros or approximately all zeros, and determining the first translation transformation based on output values of the partial processing.

With reference to the third aspect, in a possible implementation, the first regression includes: performing constrained regression through an origin on the feature of the user quantity indicator and the feature of the service usage indicator in the first dataset.

With reference to the third aspect, in a possible implementation, when diversity of the user quantity indicator in the first dataset does not meet a preset condition, performing constrained regression through an origin on the feature of the user quantity indicator and the feature of the service usage indicator in the first dataset, to obtain the first prediction model.

With reference to the third aspect, in a possible implementation, the first regression includes: when diversity of the user quantity indicator in the first dataset meets a preset condition, performing unconstrained regression through an origin on the feature of the user quantity indicator and the feature of the service usage indicator in the first dataset, to obtain the first prediction model.

With reference to the third aspect, in a possible implementation, the second feature processing includes: performing first dimension reduction mapping processing on some service usage indicators of a device in the first dataset, to obtain the feature of the service usage indicator.

With reference to the third aspect, in a possible implementation, the first dimension reduction mapping processing includes: performing feature processing based on a service usage principal component model, where the service usage principal component model is determined by performing the following step:

performing principal component analysis on a third dataset that describes a numerical relationship between features of some service usage indicators, to obtain the service usage principal component model.

With reference to the third aspect, in a possible implementation, when input values are all zeros or approximately all zeros in the first feature processing, output values are all zeros or approximately all zeros.

With reference to the third aspect, in a possible implementation, the first feature processing includes a second translation transformation, and the first translation transformation is determined by performing the following steps: performing partial processing of the first feature processing on the input values that are all zeros or approximately all zeros, and determining the second translation transformation based on output values of the partial processing.

With reference to the third aspect, in a possible implementation, the first feature processing includes: performing second dimension reduction mapping processing on some user quantity indicators of a device in the first dataset, to obtain the feature of the user quantity indicator.

With reference to the third aspect, in a possible implementation, the second dimension reduction mapping processing includes: performing feature processing based on a user quantity principal component model, where the user quantity principal component model is determined by performing the following step:

performing principal component analysis on a fourth dataset that describes a numerical relationship between features of the user quantity indicator, to obtain the principal component model that describes the user quantity indicator.

With reference to the third aspect, in a possible implementation, the second regression includes: performing quantile regression on the feature of the service usage indicator and the feature of the resource usage indicator in the second dataset, to obtain a second prediction model.

According to a fourth aspect, an apparatus for modeling a numerical relationship between a user quantity indicator and a resource usage indicator, including:

a first processing module, configured to perform first regression on a first dataset that describes a numerical relationship between a feature of a user quantity indicator and a feature of a service usage indicator, to obtain a first prediction model; and

a second processing module, configured to perform second regression on a second dataset that describes a numerical relationship between the feature of the service usage indicator and a feature of a resource usage indicator, to obtain a second prediction model. Any data sample in the first dataset corresponds to values of the user quantity indicator and values of the service usage indicator of a device combination under a condition. Original values of the user quantity indicator of some devices in the device combination are directly used as a feature of the user quantity indicator in the data sample or are input for first feature processing, and an output value of the first feature processing is used as a feature of the user quantity indicator in the data sample. Original values of the service usage indicator of some devices in the device combination are directly used as the feature of the service usage indicator in the data sample or are input for second feature processing, and an output value of the second feature processing is used as the feature of the service usage indicator in the data sample.

In the first dataset, all data samples correspond to more than one set that includes a device combination, there is at least one pair of data samples in the dataset, there is at least one user quantity indicator, and original values of the user quantity indicator in the pair of data samples are obtained from two different devices.

Any data sample in the second dataset corresponds to the values of the service usage indicator and values of the resource usage indicator of a device combination under a condition; original values of the service usage indicator of some devices in the device combination are directly used as the feature of the service usage indicator in the data sample or are input for second feature processing, and an output value of the second feature processing is used as the feature of the service usage indicator in the data sample; and original values of the resource usage indicator of some devices in the device combination are directly used as the feature of the resource usage indicator in the data sample or are input for third feature processing, and an output value of the third feature processing is used as the feature of the resource usage indicator in the data sample.

With reference to the fourth aspect, in a possible implementation, the service usage indicator is determined based on the user quantity indicator and the service usage indicator.

With reference to the fourth aspect, in a possible implementation, in the first dataset, different data samples have similar load distribution relationships between a device that provides the original value of the user quantity indicator and a device that provides the original value of the service usage indicator.

With reference to the fourth aspect, in a possible implementation, when input values are all zeros or approximately all zeros in the second feature processing, output values are all zeros or approximately all zeros.

With reference to the fourth aspect, in a possible implementation, the second feature processing includes a first translation transformation, and the first translation transformation is determined by performing the following steps:

performing partial processing of the second feature processing on the input values that are all zeros or approximately all zeros, and determining the first translation transformation based on output values of the partial processing.

With reference to the fourth aspect, in a possible implementation, the first regression includes: performing constrained regression through an origin on the feature of the user quantity indicator and the feature of the service usage indicator in the first dataset.

With reference to the fourth aspect, in a possible implementation, the first processing module is specifically configured to: when diversity of the user quantity indicator in the first dataset does not meet a preset condition, perform constrained regression through an origin on the feature of the user quantity indicator and the feature of the service usage indicator in the first dataset, to obtain the first prediction model.

With reference to the fourth aspect, in a possible implementation, the first regression includes: when diversity of the user quantity indicator in the first dataset meets a preset condition, performing unconstrained regression through an origin on the feature of the user quantity indicator and the feature of the service usage indicator in the first dataset, to obtain the first prediction model.

With reference to the fourth aspect, in a possible implementation, the second feature processing includes: performing first dimension reduction mapping processing on some service usage indicators of a device in the first dataset, to obtain the feature of the service usage indicator.

With reference to the fourth aspect, in a possible implementation, the first dimension reduction mapping processing includes: performing feature processing based on a service usage principal component model, where the service usage principal component model is determined by performing the following step:

performing principal component analysis on a third dataset that describes a numerical relationship between features of some service usage indicators, to obtain the service usage principal component model.

With reference to the fourth aspect, in a possible implementation, when input values are all zeros or approximately all zeros in the first feature processing, output values are all zeros or approximately all zeros.

With reference to the fourth aspect, in a possible implementation, the first feature processing includes a second translation transformation, and the first translation transformation is determined by performing the following steps: performing partial processing of the first feature processing on the input values that are all zeros or approximately all zeros, and determining the second translation transformation based on output values of the partial processing.

With reference to the fourth aspect, in a possible implementation, the first feature processing includes: performing second dimension reduction mapping processing on some user quantity indicators of a device in the first dataset, to obtain the feature of the user quantity indicator.

With reference to the fourth aspect, in a possible implementation, the second dimension reduction mapping processing includes: performing feature processing based on a user quantity principal component model, where the user quantity principal component model is determined by performing the following step:

performing principal component analysis on a fourth dataset that describes a numerical relationship between features of the user quantity indicator, to obtain the principal component model that describes the user quantity indicator.

With reference to the fourth aspect, in a possible implementation, the second regression includes: performing quantile regression on the feature of the service usage indicator and the feature of the resource usage indicator in the second dataset, to obtain the second prediction model.

According to a fifth aspect, a training apparatus is provided, including: a first obtaining module, configured to obtain first training data and second training data; a first training module, configured to obtain a first prediction model through training based on the first training data; and a second training module, configured to obtain a second prediction model through training based on the second training data.

In at least one embodiment, the first training data includes a first indicator data indicator and a second indicator data indicator that are of a plurality of network devices (for example, a target device and another network device), and the second training data includes the second indicator data indicator and a third indicator data indicator of the target device.

The first prediction model is used to indicate a mapping relationship between the first indicator data indicator and the second indicator data indicator of the target device. The second prediction model is used to indicate a mapping relationship between the second indicator data indicator and the third indicator data indicator of the target device.

With reference to the fifth aspect, in a possible implementation, the apparatus further includes: a second obtaining module, configured to obtain to-be-predicted first indicator data of the target device; a first determining module, configured to input the to-be-predicted first indicator data into a prediction model, to obtain predicted second indicator data of the target device; and a second determining module, configured to input the predicted second indicator data into the second prediction model, to obtain a prediction result of the target device.

In at least one embodiment, the prediction model includes the first prediction model and the second prediction model. The first prediction model is obtained through training based on the first training data. The second prediction model is obtained through training based on the second training data.

With reference to the fifth aspect, in a possible implementation, the first training module is specifically configured to: perform principal component analysis on the second indicator data in the first training data, to obtain a principal component analysis model; perform dimension reduction processing on the first training data based on the principal component analysis model, to obtain dimension-reduced third training data; and train the first prediction model based on the third training data.

With reference to the fifth aspect, in a possible implementation, the first training module is specifically configured to perform regression on the first training data to obtain the first prediction model.

With reference to the fifth aspect, in a possible implementation, the first training module is specifically configured to: when diversity of the first training data meets a preset condition, perform regression through an origin on the first training data; or when diversity of the first training data does not meet the preset condition, perform regression not through an origin on the first training data.

With reference to the fifth aspect, in a possible implementation, the second training module is specifically configured to perform regression on the second training data to obtain the second prediction model.

With reference to the fifth aspect, in a possible implementation, the second training module is specifically configured to perform quantile regression on the second training data to obtain the second prediction model.

With reference to the fifth aspect, in a possible implementation, the target device and the another network device have a consistent indicator relationship between the first indicator data indicator and the second indicator data indicator.

According to a sixth aspect, a prediction apparatus is provided, including: a first obtaining module, configured to obtain to-be-predicted first indicator data of a target device; a first determining module, configured to input the to-be-predicted first indicator data into a first prediction model, to obtain predicted second indicator data of the target device; and a second determining module, configured to input the predicted second indicator data into a second prediction model, to obtain a prediction result of the target device.

In at least one embodiment, the first prediction model is obtained through training based on first training data, the second prediction model is obtained through training based on second training data, the first training data includes first indicator data and second indicator data that are of a plurality of devices, the second training data includes the second indicator data and third indicator data that are of the target device, and the plurality of devices include the target device.

With reference to the sixth aspect, in a possible implementation, the apparatus further includes: a second obtaining module, configured to obtain first training data; and a first training module, configured to obtain the first prediction model through training based on the first training data.

In at least one embodiment, the first prediction model is used to predict the second indicator data of the target device based on the first indicator data of the target device.

With reference to the sixth aspect, in a possible implementation, the first training module is specifically configured to: perform principal component analysis on the second indicator data in the first training data, to obtain a principal component analysis model; perform dimension reduction processing on the first training data based on the principal component analysis model, to obtain dimension-reduced third training data; and train the first prediction model based on the third training data.

With reference to the sixth aspect, in a possible implementation, the first training module is specifically configured to perform regression on the first training data to obtain the first prediction model.

With reference to the sixth aspect, in a possible implementation, the first training module is specifically configured to: when diversity of the first training data meets a preset condition, perform regression through an origin on the first training data; or when diversity of the first training data does not meet the preset condition, perform regression not through an origin on the first training data.

With reference to the sixth aspect, in a possible implementation, the apparatus further includes: a third obtaining module, configured to obtain second training data of the target device, where the second training data includes the second indicator data indicator and the third indicator data indicator of the target device; and a second training module, configured to train the second prediction model of the target device based on the second training data, where the second prediction model is used to indicate a mapping relationship between the second indicator data indicator and the third indicator data indicator of the target device.

With reference to the sixth aspect, in a possible implementation, the second training module is specifically configured to perform regression on the second training data to obtain the second prediction model.

With reference to the sixth aspect, in a possible implementation, the second training module is specifically configured to perform quantile regression on the second training data to obtain the second prediction model.

With reference to the sixth aspect, in a possible implementation, the target device and another network device have a consistent indicator relationship between the first indicator data and the second indicator data.

According to a seventh aspect, a training apparatus is provided, including a memory and a processor. The memory is configured to store a program. The processor is configured to execute the program stored in the memory. When the program is executed, the processor performs the method in any one of the second aspect or the implementations of the second aspect.

According to an eighth aspect, a prediction apparatus is provided, including a memory and a processor. The memory is configured to store a program. The processor is configured to execute the program stored in the memory. When the program is executed, the processor performs the method in any one of the first aspect or the implementations of the first aspect.

According to a ninth aspect, an apparatus for modeling a numerical relationship between a user quantity indicator and a resource usage indicator is provided. The apparatus includes a memory and a processor. The memory is configured to store a program. The processor is configured to execute the program stored in the memory. When the program is executed, the processor performs the method in any one of the third aspect or the implementations of the third aspect.

According to a tenth aspect, a computer-readable storage medium is provided, including a computer instruction. When the computer instruction is run on the training apparatus, the training apparatus is enabled to perform the method in any one of the second aspect or the implementations of the second aspect.

According to an eleventh aspect, a computer-readable storage medium is provided, including a computer instruction. When the computer instruction is run on the prediction apparatus, the prediction apparatus is enabled to perform the method in any one of the first aspect or the implementations of the first aspect.

According to a twelfth aspect, a computer-readable storage medium is provided, including a computer instruction. When the computer instruction is run on the apparatus for modeling a numerical relationship between a user quantity indicator and a resource usage indicator, the prediction apparatus is enabled to perform the method in any one of the third aspect or the implementations of the third aspect.

According to a thirteenth aspect, a chip is provided, including a memory and a processor. The memory is configured to store a program. The processor is configured to execute the program stored in the memory. When the program is executed, the processor performs the method in any one of the first aspect or the implementations of the first aspect.

According to a fourteenth aspect, a chip is provided, including a memory and a processor. The memory is configured to store a program. The processor is configured to execute the program stored in the memory. When the program is executed, the processor performs the method in any one of the second aspect or the implementations of the second aspect.

According to a fifteenth aspect, a computer program product is provided. When the computer program product is run on a computer, the computer is enabled to perform the method in any one of the first aspect or the implementations of the first aspect.

According to a sixteenth aspect, a computer program product is provided. When the computer program product is run on a computer, the computer is enabled to perform the method in any one of the second aspect or the implementations of the second aspect.

### BRIEF DESCRIPTION OF DRAWINGS

FIG. 1 is a schematic flowchart of a prediction method according to at least one embodiment;

FIG. 2 is a possible schematic flowchart of a scenario of cross-device combination generalization between indicators according to at least one embodiment;

FIG. 3 is a possible schematic flowchart of a scenario of cross-device combination generalization between indicators according to at least one embodiment;

FIG. 4 is a schematic flowchart of training a first prediction model and a second prediction model according to at least one embodiment;

FIG. 5 is a schematic flowchart of training a first prediction model and a second prediction model according to at least one embodiment;

FIG. 6A and FIG. 6B are a schematic flowchart of training a first prediction model and a second prediction model according to at least one embodiment;

FIG. 7 is a schematic flowchart of training a first prediction model and a second prediction model according to at least one embodiment;

FIG. 8A and FIG. 8B are a schematic flowchart of training a first prediction model and a second prediction model according to at least one embodiment;

FIG. 9 is a schematic flowchart of training a first prediction model and a second prediction model according to at least one embodiment;

FIG. 10 is a schematic structural diagram of a training apparatus 1000 according to at least one embodiment;

FIG. 11 is a schematic structural diagram of a prediction apparatus 1100 according to at least one embodiment;

FIG. 12 is a schematic structural diagram of a training apparatus 1200 according to at least one embodiment; and

FIG. 13 is a schematic structural diagram of a prediction apparatus 1300 according to at least one embodiment.

### DESCRIPTION OF EMBODIMENTS

The following describes technical solutions with reference to accompanying drawings.

This application does not specifically limit an application scenario in which second indicator data is predicted based on first indicator data and a prediction model. This application may be applied to various communications network devices or various computer devices. For example, may be applied to a computer device in a data operation center.

At least one embodiment provides a prediction method, so that a prediction result (third indicator data) of a target device can be accurately predicted based on to-be-predicted first indicator data of the target device. The following describes at least one embodiment in detail with reference to FIG. 1.

FIG. 1 is a schematic flowchart of a prediction method according to at least one embodiment. The method in FIG. 1 may include step 110 to step 130. The following separately describes step 110 to step 130 in detail.

Step 110: Obtain to-be-predicted first indicator data of a target device.

The target device in at least one embodiment may be referred to as a to-be-modeled device.

The target device and/or a network device (also referred to as a communications network device) mentioned in are/is not specifically limited, and may include but be not limited to any subnet, a network element, a sub-device (for example, a board) of a network element, and a functional unit (for example, a module) of a network element in a network. For example, the communications network device may include but is not limited to a network adapter, a network transceiver, a network media conversion device, a multiplexer, an interrupter, a hub, a bridge, a switch, a router, a gateway, and the like.

A type of the device (also referred to as a communications network device) is not specifically limited in at least one embodiment, and may be any communications network device. For example, the device may be an advanced telephony server (advanced telephony server, ATS). For another example, the device may be a unified packet gateway (unified packet gateway, UGW).

Step 120: Input the to-be-predicted first indicator data into a first prediction model, to obtain predicted second indicator data of the target device.

The prediction model is not specifically limited in at least one embodiment. In an example, there may be one prediction model. In another example, there may be two prediction models. For example, the prediction models may include the first prediction model and a second prediction model.

In at least one embodiment, the first prediction model is obtained through training based on first training data, and the second prediction model is obtained through training based on second training data.

In at least one embodiment, the first training data may include first indicator data and second indicator data that are of a plurality of devices.

In at least one embodiment, the first indicator data and the second indicator data may be from a plurality of network devices including the target device.

The first indicator data and the second indicator data are not specifically limited in at least one embodiment. The first indicator data and the second indicator data may be two pieces of positively correlated indicator data, or may be two pieces of negatively correlated indicator data.

Step 130: Input the predicted second indicator data into the second prediction model, to obtain a prediction result of the target device.

In at least one embodiment, the second prediction model may be obtained through training based on the second training data, and the second training data may include the second indicator data and third indicator data that are of the target device.

In at least one embodiment, the second indicator data and the third indicator data may be from the target device, or may be from the plurality of network devices including the target device. This is not specifically limited in.

In at least one embodiment, the predicted second indicator output from the first prediction model may be input into the second prediction model, to obtain the prediction result of the target device, that is, predicted third indicator data output from the second prediction model.

In some embodiments, the first indicator data may be a user quantity, the second indicator data may be a traffic volume, and the third indicator data may be resource usage. In at least one embodiment, traffic volume is an example of service usage, and a traffic volume indicator is an example of a service usage indicator.

The following provides detailed descriptions by using an example in which the first indicator data is the user quantity and the second indicator data is the traffic volume.

The user quantity indicator in at least one embodiment may be represented as a quantity of users that use a service on a communications network device.

In at least one embodiment, there may be a plurality of user quantity indicators for one communications network device. In an example, the user quantity may be represented as an indicator “2G+3G user quantity”. In another example, the user quantity may be represented as an indicator “4G user quantity”. In another example, the user quantity may be represented as an indicator “registered-user quantity”. This is not specifically limited in at least one embodiment.

In at least one embodiment, the traffic volume indicator may be understood as a quantity of users that use a service on a communications network device.

In at least one embodiment, there may be a plurality of traffic volume indicators of one device. In an example, the traffic volume of the communications network device may be represented as an indicator “total traffic volume usage” of the network device. In another example, the traffic volume of the communications network device may be represented as an indicator “Gi interface packet quantity” of the network device. In another example, the traffic volume of the communications network device may be represented as an indicator “SGi user-plane packet quantity” of the network device. This is not specifically limited in at least one embodiment.

In at least one embodiment, the “traffic volume” indicator may be related to the “user quantity” indicator (also referred to as a user quantity), user communication frequency, and user communication duration. Within a unit time, a larger “user quantity” indicator and longer communication duration indicate a larger “traffic volume” indicator.

The foregoing provides a description that a plurality of devices have a consistent indicator relationship between the user quantity indicator and the traffic volume indicator. In some embodiments, the plurality of devices have a same or basically same change tendency in the indicator relationship between the user quantity indicator and the traffic volume indicator.

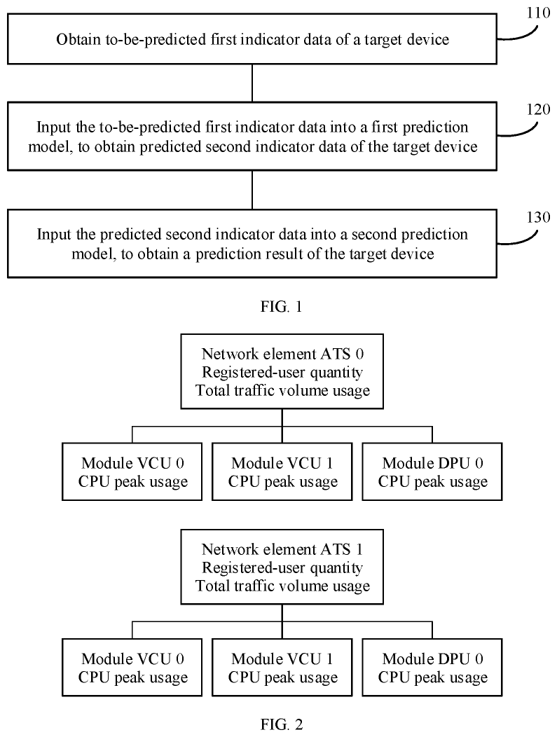

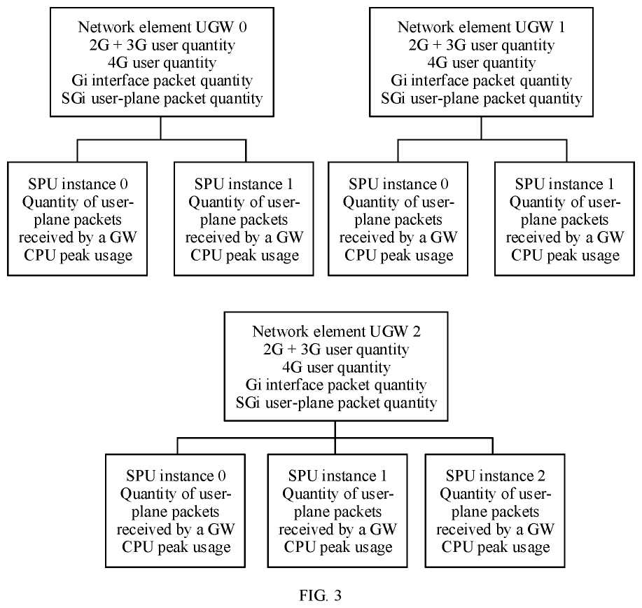

The following describes in detail, with reference to FIG. 2 and FIG. 3, that a plurality of devices have a consistent indicator relationship between the user quantity indicator and the traffic volume indicator. Details are not described herein now.

In at least one embodiment, the resource usage indicator may be represented as resource consumption of a communications network device. The resource usage may be specific resource usage corresponding to a user quantity. For example, a CPU usage corresponding to a specific user quantity is 80%.

In at least one embodiment, different devices may have different resource usage indicators. In an example, the resource usage indicator may be represented as an indicator “CPU peak usage”. In another example, the resource usage indicator may be represented as an indicator “memory usage”. In another example, the resource usage indicator may be represented as an indicator “license usage”. This is not specifically limited in at least one embodiment.

In at least one embodiment, the first prediction model may be obtained through training by using collected first training data of a plurality of devices (including the target device and another network device), so that diversity of historical data samples of the first indicator data can be increased. In addition, the second prediction model may be obtained through training by using the collected second training data of the target device, so that a function relationship between the first indicator data and the second indicator data can be more accurately reflected.

In some embodiments, the first training data may be further obtained, and the first prediction model is obtained through training based on the first training data.

In some embodiments, the second training data may be further obtained, and the second prediction model is obtained through training based on the second training data.

In at least one embodiment, the first prediction model may be used to predict the second indicator data of the target device based on the first indicator data of the target device, and the second prediction model is used to predict the third indicator data of the target device based on the second indicator data that is of the target device and that is obtained based on the first prediction model.

The following provides detailed descriptions by using an example in which the first indicator data is the user quantity, the second indicator data is the traffic volume, and the third indicator data is the resource usage.

In some embodiments, the second prediction model may alternatively be referred to as a “user quantity—traffic volume model”.

In at least one embodiment, the user quantity indicator and/or the traffic volume indicator in the first training data may be directly trained to obtain the first prediction model; or feature processing may be performed on the user quantity indicator and/or the traffic volume indicator, and feature-processed data is trained to obtain the first prediction model. This is not specifically limited in.

In at least one embodiment, feature processing is performed on indicators (for example, the user quantity indicator, the traffic volume indicator, and the resource usage indicator) collected from a device, to make feature-processed data have a numerical feature for mathematical use. For example, an average value, a variance, and the like may be calculated for values of some features within a specific interval. For example, both standardization (Standardization) and normalization (Normalization) are common feature processing means for data transformation.

Feature processing is performed on the indicators (for example, the user quantity indicator, the traffic volume indicator, and the resource usage indicator) collected from the device, and specific information may also be extracted from the indicators for subsequent analysis. For example, a positive sign and a negative sign of a value may be marked.

In at least one embodiment, feature processing is performed on the user quantity indicator and/or the traffic volume indicator in a plurality of specific implementations. In an example, standardization (standardization) processing may be performed on the user quantity indicator and/or the traffic volume indicator. In another example, normalization (normalization) processing may alternatively be performed on the user quantity indicator and/or the traffic volume indicator. In another example, dimension reduction processing may alternatively be performed on the user quantity indicator and/or the traffic volume indicator. For example, principal component analysis may be performed on the user quantity indicator and/or the traffic volume indicator. The following provides detailed descriptions with reference to specific embodiments, and details are not described herein now.

An implementation of obtaining the first prediction model through training by using the first training data is not specifically limited in at least one embodiment. In an example, regression may be performed on the first training data to obtain the first prediction model. In another example, regression through the origin may be performed on the first training data to obtain the first prediction model. The following provides detailed descriptions with reference to specific embodiments, and details are not described herein now.

In at least one embodiment, the second prediction model may be used to indicate a mapping relationship between the traffic volume indicator and the resource usage indicator of the target device.

In some embodiments, the second prediction model may be referred to as a “traffic volume-resource usage model”.

In at least one embodiment, the traffic volume indicator and/or the resource usage indicator in the second training data may be directly trained to obtain the second prediction model; or feature processing may be performed on the traffic volume indicator and/or the resource usage indicator, and feature-processed data is trained to obtain the second prediction model. This is not specifically limited in.

In at least one embodiment, feature processing is performed on the traffic volume indicator and/or the resource usage indicator in a plurality of specific implementations. In an example, standardization (standardization) processing may be performed on the traffic volume indicator and/or the resource usage indicator. In another example, normalization (normalization) processing may alternatively be performed on the traffic volume indicator and/or the resource usage indicator. In another example, dimension reduction processing may alternatively be performed on the traffic volume indicator and/or the resource usage indicator. For example, a principal component analysis may alternatively be performed on the traffic volume indicator and/or the resource usage indicator. The following provides detailed descriptions with reference to specific embodiments, and details are not described herein now.

An implementation of obtaining the second prediction model through training by using the second training data is not specifically limited in at least one embodiment. In an example, regression may be performed on the second training data to obtain the second prediction model. In another example, regression through the origin may alternatively be performed on the second training data to obtain the second prediction model. The following provides detailed descriptions with reference to specific embodiments, and details are not described herein now.

In at least one embodiment, the first prediction model may be obtained through training by using collected first training data of the plurality of devices (including the target device and the another network device), so that diversity of historical data samples of the user quantity indicator can be increased. In addition, the second prediction model may be obtained through training by using the collected second training data of the target device, so that a function relationship between the user quantity indicator and the resource usage indicator can be more accurately reflected.

In some embodiments, a predicted user quantity of the target device may be obtained, and predicted resource usage corresponding to the predicted user quantity of the target device may be obtained based on the predicted user quantity by using the foregoing described first prediction model and second prediction model.

In at least one embodiment, accurate predicted resource usage of a network device (the target device) can be obtained based on the predicted user quantity. Before carrying out an activity, a network operator may obtain the resource usage that is of the network device and that corresponds to the predicted user quantity, and may pre-expand a to-be-overloaded network device.

The following provides, with reference to specific examples, more detailed descriptions of a specific implementation in which the target device and the another network device have a consistent indicator relationship between the user quantity indicator and the traffic volume indicator in at least one embodiment. It should be noted that the following examples are merely intended to help a person skilled in the art understand at least one embodiment, instead of limiting at least one embodiment to a specific value or a specific scenario shown in the examples. A person skilled in the art can definitely make various equivalent modifications or changes according to the examples described above, and such modifications and changes also fall within the scope of some embodiments.

In at least one embodiment, in FIG. 2 and FIG. 3, the user quantity corresponds to the first indicator data, the traffic volume corresponds to the second indicator data, and the resource usage corresponds to the third indicator data indicator.

FIG. 2 is a possible schematic flowchart of a scenario of cross-device combination generalization between indicators according to at least one embodiment. As shown in FIG. 2, network elements ATS 0 and ATS 1 are communications devices of a same type. The communications device may have a hierarchical decomposition structure. The network element ATS 0 may be decomposed into modules: a VCU 0, a VCU 1, and a DPU 0, and the network element ATS 1 may be decomposed into modules: a VCU 0, a VCU 1, and a DPU 0.

A network element ATS may be an advanced telephony server. In an example, the network element ATS may provide a basic call service. For example, the network element ATS may provide a basic voice call function and a video telephony function for a user. In another example, the network element ATS may provide some supplementary services. For example, the network element ATS may provide additional enhanced system functions such as display, call barring, transfer, callback, conference, and notification.

Services of the network element ATS 0 may be evenly loaded among the three modules (the VCU 0, the VCU 1, and the DPU 0) of the ATS 0. Services of the network element ATS 1 may be evenly loaded among the three modules (the VCU 0, the VCU 1, and the DPU 0) of the ATS 1. A dispatch process unit (dispatch process unit, DPU) may be configured to execute a control policy configured by an engineer, and can implement functions such as data collection, scale conversion, alarm threshold check, operation recording, and sequential time recording.

Referring to FIG. 2, a user quantity indicator (for example, the indicator “registered-user quantity”) may correspond to network elements (the ATS 0 and the ATS 1), and a traffic volume indicator (for example, the indicator “total traffic volume usage”) may correspond to the network elements (the ATS 0 and the ATS 1), and a resource usage indicator (for example, the indicator “CPU peak usage”) may correspond to the modules (the VCU 0, the VCU 1, and the DPU 0) of the network elements (the ATS 0 and the ATS 1).

The ATS 0 and the ATS 1 are communications device of a same type. The indicator “registered-user quantity” and the indicator “total traffic volume usage” both correspond to the network elements, and a definition of the indicator “registered-user quantity” and a definition of the indicator “total traffic volume usage” of the network element ATS 0 are respectively the same as a definition of the indicator “registered-user quantity” and a definition of the indicator “total traffic volume usage” of the network element ATS 1. Therefore, a correlation between the indicator “registered-user quantity” and the indicator “total traffic volume usage” has cross-device combination generalization between the network element ATS 0 and the network element ATS 1. In other words, a model obtained through training based on the correlation between the indicator “registered-user quantity” and the indicator “total traffic volume usage” is applicable to both the network element ATS 0 and the network element ATS 1. For example, if the indicator “registered-user quantity” of the network element ATS 0 is the same as the indicator “registered-user quantity” of the network element ATS 1, the indicator “total traffic volume usage” of the network element ATS 0 may be the same as or basically the same as the indicator “total traffic volume usage” of the network element ATS 1.

In at least one embodiment, the user quantity indicator (for example, the indicator “registered-user quantity”) and the traffic volume indicator (for example, the indicator “total traffic volume usage”) shown in FIG. 2 may be from a target device (for example, the network element ATS 0) and another network device (for example, the network element ATS 1). Because the network element ATS 0 and the network element ATS 1 have a same or basically same change tendency in the indicator relationship between the indicator “registered-user quantity” and the indicator “total traffic volume usage”, diversity of historical data samples of the user quantity indicator can be increased by collecting the user quantity indicator and the traffic volume indicator that are of the network element ATS 0 and the network element ATS 1.

FIG. 3 is a possible schematic flowchart of a scenario of cross-device combination generalization between indicators according to at least one embodiment. As shown in FIG. 3, network elements UGW 0, UGW 1, and UGW 2 are communications devices of a same type. The communications device may have a hierarchical decomposition structure. The network element UGW 0 may be decomposed into modules: an SPU instance 0 and an SPU instance 1. The network element UGW 1 may be decomposed into modules: an SPU instance 0 and an SPU instance 1. The network element UGW 2 may be decomposed into modules: an SPU instance 0, an SPU instance 1, and an SPU instance 2.

A network element UGW may be a unified packet gateway, and services of the network element UGW 0 may be loaded between the modules: SPU instances of the UGW 0. A service process unit (service process unit, SPU) instance may be configured to provide a service function requirement such as load balancing or firewall in a network application scenario. An efficient load balancing solution provided by the SPU can be used to resolve problems such as a slow response, an excessively high apply latency, and unbalanced device traffic in an information technology (information technology, IT) system, thereby ensuring service reliability, increasing a service response speed, and facilitating flexible service expansion.

Referring to FIG. 3, services of the network element UGW 0 may be evenly loaded between the two modules (the SPU instance 0 and the SPU instance 1) of the network element UGW 0; services of the network element UGW 1 may be evenly loaded between the two modules (the SPU instance 0 and the SPU instance 1) of the network element UGW 1; and services of the UGW 2 may be evenly loaded among the three modules (the SPU instance 0, the SPU instance 1, and the SPU instance 2) of the network element UGW 2.

User quantity indicators (for example, the indicators “2G+3G user quantity” and “4G user quantity”) may correspond to the network elements (the UGW 0, the UGW 1, and the UGW 2). Traffic volume indicators (for example, the indicators “Gi interface packet quantity” and “SGi interface packet quantity”) may correspond to the network elements (the UGW 0, the UGW 1, and the UGW 2). A traffic volume indicator (for example, the indicator “quantity of user-plane packets received by a GW”) may correspond to an SPU instance.

The network elements UGW 0, UGW 1, and UGW 2 are communications devices of a same type. The indicators “2G+3G user quantity”, “4G user quantity”, “Gi interface packet quantity”, and “SGi interface packet quantity” all correspond to the network elements UGW 0, UGW 1, and UGW 2. In addition, definitions of the indicators “2G+3G user quantity”, “4G user quantity”, “Gi interface packet quantity”, and “SGi interface packet quantity” are respectively the same as definitions of the indicators of the network elements UGW 0, UGW 1, and UGW 2. Therefore, a correlation between the indicators “2G+3G user quantity”, “4G user quantity”, “Gi interface packet quantity”, and “SGi interface packet quantity” has cross-device combination generalization among the network elements UGW 0, UGW 1, and UGW 2.

The indicator “quantity of user-plane packets received by a GW” corresponds to the module: the SPU instance of the network element. As shown in FIG. 3, a quantity of SPU instances of the network element UGW 2 is different from quantities of SPU instances of the network element UGW 0 and the network element UGW 1, so that a decomposition relationship between the SPU instances of the network element UGW 2 may be different from decomposition relationships between the SPU instances of the UGW 0 and the UGW 1. Therefore, the correlation between the indicators “2G+3G user quantity”, “4G user quantity”, and “quantity of user-plane packets received by a GW” has cross-device combination generalization between the network elements UGW 0 and UGW 1, but the relationship has no cross-device combination generalization between the network elements UGW 0, UGW 1, and UGW 2.

As shown in FIG. 3, the correlation between the user quantity indicators (for example, the indicators “2G+3G user quantity” and “4G user quantity”) and the traffic volume indicators (for example, the indicators “Gi interface packet quantity”, “SGi interface packet quantity”, and “quantity of user-plane packets received by a GW”) may have cross-device combination generalization between the network elements UGW 0 and UGW 1. In other words, a model obtained through training based on the correlation between the indicators “2G+3G user quantity”, “4G user quantity”, “Gi interface packet quantity”, “SGi interface packet quantity”, and “quantity of user-plane packets received by a GW” is applicable to both the network element UGW 0 and the network element UGW 1.

In at least one embodiment, the correlation between the user quantity indicators (for example, the indicators “2G+3G user quantity” and “4G user quantity”) and the traffic volume indicators (for example, the indicators “Gi interface packet quantity”, “SGi interface packet quantity”, and “quantity of user-plane packets received by a GW”) may have cross-device combination generalization between the network elements UGW 0 and UGW 1. Data of the user quantity indicator and the traffic volume indicator of a target device (for example, the network element UGW 0) and data of the user quantity indicator and the traffic volume indicator of another network device (for example, the network element UGW 1) may be collected, so that diversity of historical data samples of the user quantity indicator can be increased.

In some embodiments, regression may be performed on first training data and/or second training data to obtain a first prediction model.

In at least one embodiment, the first prediction model and/or a second prediction model may be obtained through training by using the regression method, so that degrees of correlation and fitting between factors can be accurately calculated and measured. This manner is characterized by simple calculation and easy implementation.

The following provides detailed descriptions by using an example in which the first indicator data is the user quantity, the second indicator data is the traffic volume, and the third indicator data is the resource usage.

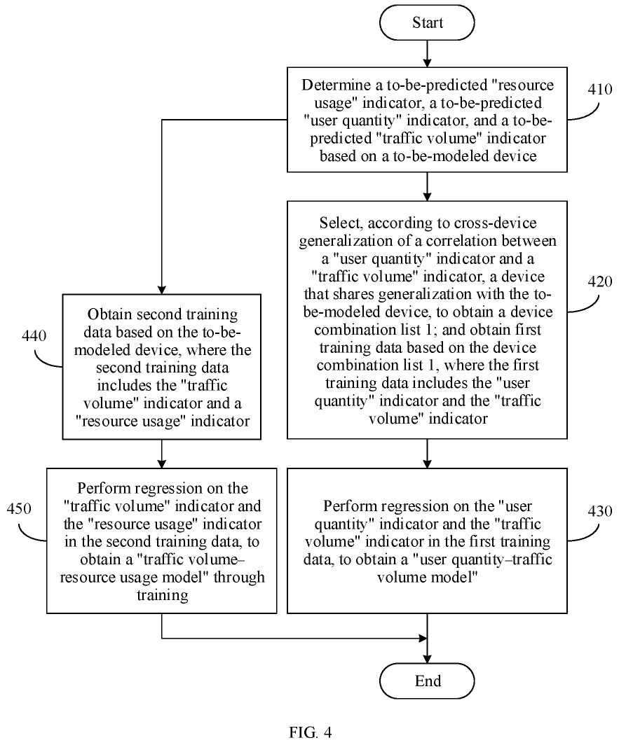

The following provides, with reference to FIG. 4, detailed example descriptions, by using an example in which the first prediction model and/or the second prediction model are/is obtained through training by performing regression on the first training data and/or the second training data.

FIG. 4 is a schematic flowchart of training a first prediction model and a second prediction model according to at least one embodiment. FIG. 4 includes step 410 to step 450. The following separately describes step 410 to step 450 in detail.

The following describes, by using the training scenario shown in FIG. 3 as an example, the process of training the first prediction model and the second prediction model in detail.

A to-be-modeled device shown in FIG. 3 may correspond to a target device in at least one embodiment.

Step 410: Determine a to-be-predicted “resource usage” indicator, a to-be-predicted “user quantity” indicator, and a to-be-predicted “traffic volume” indicator based on the to-be-modeled device.

As shown in FIG. 3, it is determined, based on the to-be-modeled device, that the to-be-predicted user quantity indicators are an indicator “2G+3G user quantity” of a network element UGW and an indicator “4G user quantity” of the network element UGW, that the to-be-predicted resource usage indicator is an indicator “CPU peak usage” of an SPU instance, and that the to-be-predicted traffic volume indicators are an indicator “Gi interface packet quantity” of the network element UGW, an indicator “SGi user-plane packet quantity” of the network element UGW, and an indicator “quantity of user-plane packets received by a GW” of the SPU instance.

Step 420: Select, according to cross-device generalization of a correlation between a “user quantity” indicator and a “traffic volume” indicator, a device that shares generalization with the to-be-modeled device, to obtain a device combination list 1; and obtain first training data based on the device combination list 1, where the first training data includes the “user quantity” indicator and the “traffic volume” indicator.

The UGW 0, the UGW 1, and the UGW 2 are devices of a same type. Definitions of the following indicators are respectively the same for the three devices: the indicator “2G+3G user quantity” of the network element UGW, the indicator “4G user quantity” of the network element UGW, the indicator “Gi interface packet quantity” of the network element UGW, and the indicator “SGi user-plane packet quantity” of the network element UGW, and all the indicators correspond to the network elements. Therefore, it may be determined that the correlation between these indicators has cross-device combination generalization between the three devices: the UGW 0, the UGW 1, and the UGW 2. However, the indicator “quantity of user-plane packets received by a GW” of the SPU instance does not correspond to a network element UGW. In addition, because a quantity of SPU instances of the UGW 2 is different from quantities of SPU instances of the UGW 0 and the UGW 1, a decomposition relationship of services loaded among the SPU instances of the UGW 2 is different from decomposition relationships of services loaded among the SPU instances of the UGW 0 and the UGW 1. Therefore, the indicator “2G+3G user quantity” of the network element UGW, the indicator “4G user quantity” of the network element UGW, and the indicator “quantity of user-plane packets received by a GW” of the SPU instance have cross-device combination generalization among the following four device combinations: UGW 0+SPU instance 0, UGW 0+SPU instance 1, UGW 1+SPU instance 0, and UGW 1+SPU instance 1. Cross-device combination generalization also exists among the following three device combinations: UGW 2+SPU instance 0, UGW 2+SPU instance 1, and UGW 2+SPU instance 2. However, cross-device combination generalization does not exist among the seven device combinations.

It is determined, based on information that the user quantity indicators are the indicator “2G+3G user quantity” of the network element UGW and the indicator “4G user quantity” of the network element UGW and based on information that the traffic volume indicators are the indicator “Gi interface packet quantity” of the network element UGW, the indicator “SGi user-plane packet quantity” of the network element UGW, and the indicator “quantity of user-plane packets received by a GW” of the SPU instance, that value samples are from the following four device combinations: UGW 0+SPU instance 0, UGW 0+SPU instance 1, UGW 1+SPU instance 0, and UGW 1+SPU instance 1. Values of the indicators “2G+3G user quantity”, “4G user quantity”, “Gi interface packet quantity”, “SGi user-plane packet quantity”, and “quantity of user-plane packets received by a GW” of one device combination at peak time (for example, 17:00) of a day are used as a data sample, to obtain the first training data.

Four device combinations may be selected as data sources of the first training data, or three device combinations may be selected as data sources of the first training data. In at least one embodiment, four device combinations are selected.

Step 430: Perform regression on the “user quantity” indicator and the “traffic volume” indicator in the first training data, to obtain a “user quantity—traffic volume model”.

Data of the network elements UGW 0 and UGW 1 may be obtained, where the data includes the indicators “2G+3G user quantity”, “4G user quantity”, “Gi interface packet quantity”, and “SGi user-plane packet quantity” of the network elements, and the indicator “quantity of user-plane packets received by a GW” of the SPU instance. Filtering may be performed on the obtained data of the network elements UGW 0 and UGW 1, and regression may be performed on data obtained after filtering, so that the “user quantity—traffic volume model” (which is also referred to as the first prediction model) of the network elements UGW 0 and UGW 1 may be obtained. For example, assuming that filtering is performed by using the peak time 17:00 of a day as peak time, regression may be performed on the indicators “2G+3G user quantity”, “4G user quantity”, “Gi interface packet quantity”, and “SGi user-plane packet quantity” in the data obtained after filtering, so that the “user quantity—traffic volume model” (the first prediction model) of the network elements UGW 0 and UGW 1 can be obtained through training.

Step 440: Obtain second training data based on the to-be-modeled device, where the second training data includes the “traffic volume” indicator and a “resource usage” indicator.

It is determined, based on information that the traffic volume indicators are an indicator “Gi interface packet quantity” of the network element UGW, an indicator “SGi user-plane packet quantity” of the network element UGW, and an indicator “quantity of user-plane packets received by a GW” of the SPU instance and based on information that the resource usage indicator is an indicator “CPU peak usage” of the SPU instance, that data samples are from target devices: the UGW 0 and the SPU instance 0. Values of the indicators “Gi interface packet quantity”, “SGi user-plane packet quantity”, “quantity of user-plane packets received by a GW”, and “CPU peak usage” of the device at any time point of a day are used as a data sample, to obtain the second training data.

Step 450: Perform regression on the “traffic volume” indicator and the “resource usage” indicator in the second training data, to obtain a “traffic volume-resource usage model” through training.

Using the indicators “Gi interface packet quantity”, “SGi user-plane packet quantity”, and “quantity of user-plane packets received by a GW” of the UGW 0 and the SPU instance 0 (a target device) as the traffic volume indicators, and using the indicator “CPU peak usage” of the UGW 0 and the SPU instance 0 (the target device) as the resource usage indicator, regression is performed on the traffic volume indicator and the resource usage indicator, so that the “traffic volume-resource usage model” (the second prediction model) of the UGW 0 and the SPU instance 0 (the target device) can be obtained through training.

In some embodiments, a prediction procedure for the SPU instance 0 of the network element UGW 0 may be as follows:

Step 1: Based on information that a device type of the SPU instance 0 of the network element UGW 0 is an SPU device of a UGW device, it may be determined that user quantity indicators that are input into the first prediction model (the “user quantity—traffic volume model”) are an indicator “2G+3G user quantity” of a network element and an indicator “4G user quantity” of the network element, and further a “predicted 2G+3G user quantity” and a “predicted 4G user quantity” may be determined.

Step 2: Based on information that a to-be-predicted device is the SPU instance 0 of the network element UGW 0, the first prediction model (the “user quantity—traffic volume model”) and a “predicted registered-user quantity” that correspond to the device may be determined, and a “predicted Gi interface packet quantity”, a “predicted SGi user-plane packet quantity”, and a “predicted kilobytes of user-plane packets received by a GW” may be obtained.

Step 3: Based on information that the to-be-predicted device is the SPU instance 0 of the UGW 0, the corresponding second prediction model (the “traffic volume-resource usage model”) may be determined, and a “predicted CPU peak usage” may be obtained based on the “traffic volume-resource usage model”, the “predicted Gi interface packet quantity”, the “predicted SGi user-plane packet quantity”, and the “predicted kilobytes of user-plane packets received by a GW”.

In some embodiments, quantile regression may be performed on the second training data to obtain the second prediction model.

In at least one embodiment, quantile regression may be one of regression methods. A quantile may be a numerical value point used to divide a distribution range of a random variable according to a probability ratio. Quantile regression may be used to predict an upper bound or a lower bound of an indicator. In an example, a quantile parameter 0.1 may be used to indicate that a distribution range of a variable is divided into two parts, and a probability that the variable is less than the quantile 0.1 may be 0.1. For example, if a lower bound of the resource usage indicator needs to be predicted, a smaller quantile value 0.1 or 0.2 may be selected.

A method for performing quantile regression on the second indicator data and the third indicator data in the second training data is not specifically limited in at least one embodiment. In an example, a linear quantile regression method may be used. In another example, a non-linear quantile regression method may be used.

In at least one embodiment, the second prediction model is trained through quantile regression, and can be used to predict an upper bound and a lower bound, rather than an average value, of the third indicator data, to meet a concern of an application requirement for a boundary value.

The following provides detailed descriptions by using an example in which the first indicator data is the user quantity, the second indicator data is the traffic volume, and the third indicator data is the resource usage.

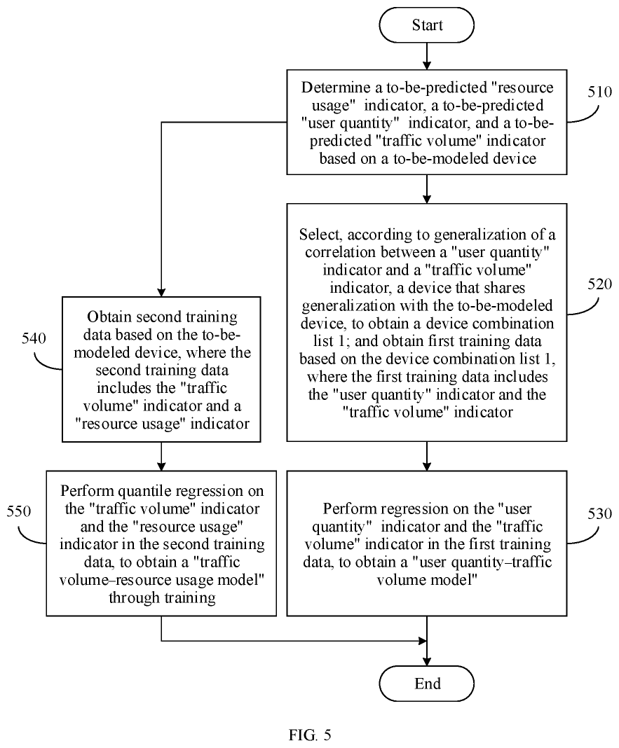

Optionally, based on FIG. 4, quantile regression may be performed on the traffic volume indicator and the resource usage indicator in the second training data, to obtain the second prediction model through training. The following describes this implementation in detail with reference to FIG. 5.

FIG. 5 is a schematic flowchart of training a first prediction model and a second prediction model according to at least one embodiment. FIG. 5 includes step 510 to step 550. Step 510 to step 540 are respectively corresponding to step 410 to step 440. For details, refer to the description in FIG. 4. Details are not described herein again.

The following describes a process of training the first prediction model and the second prediction model in detail by using the training scenario shown in FIG. 3 as an example.

Step 510: Determine a to-be-predicted “resource usage” indicator, a to-be-predicted “user quantity” indicator, and a to-be-predicted “traffic volume” indicator based on a to-be-modeled device.

Step 520: Select, according to generalization of a correlation between a “user quantity” indicator and a “traffic volume” indicator, a device that shares generalization with the to-be-modeled device, to obtain a device combination list 1; and obtain first training data based on the device combination list 1, where the first training data includes the “user quantity” indicator and the “traffic volume” indicator.

Step 530: Perform regression on the “user quantity” indicator and the “traffic volume” indicator in the first training data, to obtain a “user quantity—traffic volume model”.

Step 540: Obtain second training data based on the to-be-modeled device, where the second training data includes the “traffic volume” indicator and a “resource usage” indicator.

Step 550: Perform quantile regression on the “traffic volume” indicator and the “resource usage” indicator in the second training data, to obtain a “traffic volume-resource usage model” through training.

Using indicators “Gi interface packet quantity”, “SGi user-plane packet quantity”, and “quantity of user-plane packets received by a GW” of the UGW 0 and the SPU instance 0 (a target device) as the traffic volume indicators, and using the indicator “CPU peak usage” as the resource usage indicator, quantile regression is performed on the traffic volume indicator and the resource usage indicator, to obtain the “traffic volume-resource usage model” (the second prediction model) of the UGW 0 and the SPU instance 0 (the target device) through training.

In an example, if an upper bound of the indicator “CPU peak usage” needs to be predicted, a larger quantile value, for example, 0.8 or 0.9, may be selected. In another example, if a lower bound of the indicator “CPU peak usage” needs to be predicted, a smaller quantile value, for example, 0.1 or 0.2, may be selected.

In at least one embodiment, the second prediction model is obtained through quantile regression, and can be used to predict an upper bound and a lower bound, rather than an average value, of the third indicator data, to meet a concern of an application requirement for a boundary value.

In some embodiments, a “constrained modeling” feature may be added to the process of establishing the first prediction model by performing regression on the first indicator data and the second indicator data in the first training data. In other words, data diversity of the first indicator data may be determined. If data diversity of the first indicator data in the first training data does not meet the preset condition, constrained regression through the origin is performed on the first indicator data and the second indicator data in the first training data. If data diversity of the first indicator data in the first training data meets the preset condition, unconstrained regression through the origin may be performed on the first indicator data and the second indicator data in the first training data.

In at least one embodiment, when diversity of the first indicator data in the first training data meets the preset condition, unconstrained regression through the origin may be performed, to fully use information provided in a dataset, so as to obtain a more accurate model.

In at least one embodiment, constrained regression through the origin is performed on the first indicator data and the second indicator data, so that model extrapolation is inaccurate due to insufficient diversity of the first indicator data in the dataset is avoided.

In at least one embodiment, the preset condition mentioned above may be a preset threshold. If data diversity of the first indicator data reaches the preset threshold, it may indicate that data diversity of the first indicator data meets the preset condition.

In at least one embodiment, both regression through the origin and regression not through the origin performed on data may be considered as regression performed on the data. A model obtained through constrained regression through the origin may not include a constant term, and a model obtained through unconstrained regression through the origin may include a constant term. In an example, for a regression model obtained through regression through the origin, when a variable X is 0, a predicted variable Y is necessary 0. Regression through the origin can be easier in calculation and implementation. Usually, regression through specified coordinates rather than the origin may be usually converted into regression through the origin. In another example, for a regression model obtained through regression not through the origin, when a variable X is 0, a predicted variable Y is not necessary 0.

In some embodiments, some feature processing may be performed on the first indicator data before diversity determining is performed on the first indicator data. This is not specifically limited in. In an example, normalization (normalization) processing may be performed on the first indicator data, and data diversity determining may be performed on normalization-processed first indicator data. In another example, standardization (standardization) processing may be performed on the first indicator data, and data diversity determining may be performed on standardization-processed first indicator data. In another example, dimension reduction processing may be performed on the first indicator data, and data diversity determining may be performed on dimension-reduction-processed first indicator data.

The following provides detailed descriptions by using an example in which the first indicator data is the user quantity, the second indicator data is the traffic volume, and the third indicator data is the resource usage.

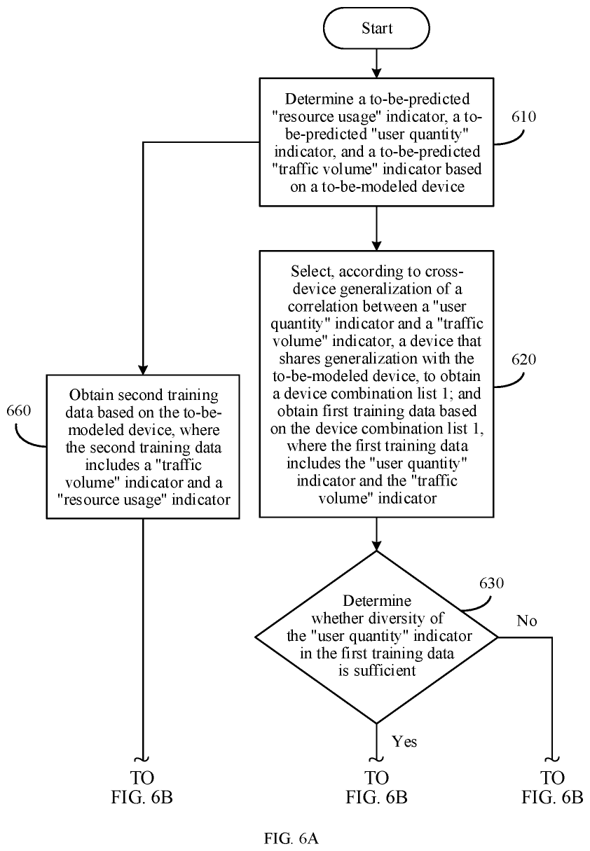

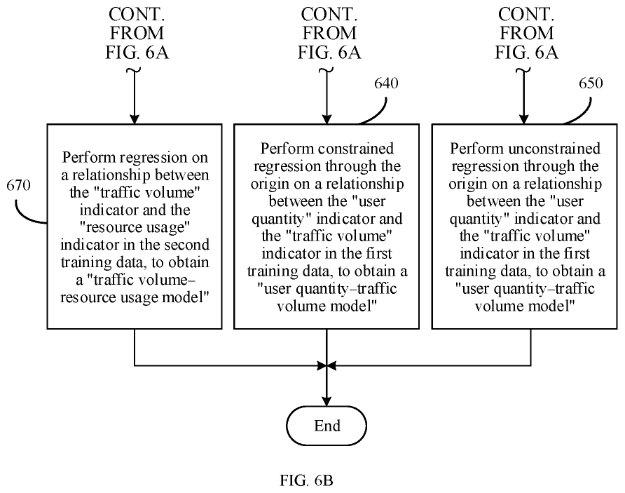

Optionally, based on FIG. 4, determining of diversity of the user quantity indicator may be added. The following describes this implementation in detail with reference to FIG. 6A and FIG. 6B.

FIG. 6A and FIG. 6B are a schematic flowchart of training a first prediction model and a second prediction model according to at least one embodiment. The method in FIG. 6A and FIG. 6B includes step 610 to step 670. The following separately describes step 610 to step 670 in detail.

The following describes a process of training the first prediction model and the second prediction model in detail by using the training scenario shown in FIG. 3 as an example.

Step 610: Determine a to-be-predicted “resource usage” indicator, a to-be-predicted “user quantity” indicator, and a to-be-predicted “traffic volume” indicator based on a to-be-modeled device.

As shown in FIG. 3, it is determined, based on the to-be-modeled device, that the to-be-predicted user quantity indicators are an indicator “2G+3G user quantity” of a network element UGW and an indicator “4G user quantity” of the network element UGW, that the to-be-predicted resource usage indicator is an indicator “CPU peak usage” of an SPU instance, and that the to-be-predicted traffic volume indicators are an indicator “Gi interface packet quantity” of the network element UGW, an indicator “SGi user-plane packet quantity” of the network element UGW, and an indicator “quantity of user-plane packets received by a GW” of the SPU instance.

Step 620: Select, according to cross-device generalization of a correlation between a “user quantity” indicator and a “traffic volume” indicator, a device that shares generalization with the to-be-modeled device, to obtain a device combination list 1; and obtain first training data based on the device combination list 1, where the first training data includes the “user quantity” indicator and the “traffic volume” indicator.

The UGW 0, the UGW 1, and the UGW 2 are devices of a same type. Definitions of the following indicators are respectively the same for the three devices: the indicator “2G+3G user quantity” of the network element UGW, the indicator “4G user quantity” of the network element UGW, the indicator “Gi interface packet quantity” of the network element UGW, and the indicator “SGi user-plane packet quantity” of the network element UGW, and all the indicators correspond to the network elements. Therefore, it may be determined that the correlation between these indicators has cross-device combination generalization between the three devices: the UGW 0, the UGW 1, and the UGW 2. However, the indicator “quantity of user-plane packets received by a GW” of the SPU instance does not correspond to a network element UGW. In addition, because a quantity of SPU instances of the UGW 2 is different from quantities of SPU instances of the UGW 0 and the UGW 1, a decomposition relationship of services loaded among SPU instances of the UGW 2 is different from decomposition relationships of services loaded among the SPU instances of the UGW 0 and the UGW 1. Therefore, the indicator “2G+3G user quantity” of the network element UGW, the indicator “4G user quantity” of the network element UGW, and the indicator “quantity of user-plane packets received by a GW” of the SPU instance have cross-device combination generalization among the following four device combinations: UGW 0+SPU instance 0, UGW 0+SPU instance 1, UGW 1+SPU instance 0, and UGW 1+SPU instance 1. Cross-device combination generalization also exists among the following three device combinations: UGW 2+SPU instance 0, UGW 2+SPU instance 1, and UGW 2+SPU instance 2. However, cross-device combination generalization does not exist among the seven device combinations.

It is determined, based on information that the user quantity indicators are the indicator “2G+3G user quantity” of the network element UGW and the indicator “4G user quantity” of the network element UGW and based on information that the traffic volume indicators are the indicator “Gi interface packet quantity” of the network element UGW, the indicator “SGi user-plane packet quantity” of the network element UGW, and the indicator “quantity of user-plane packets received by a GW” of the SPU instance, that value samples are from the following four device combinations: UGW 0+SPU instance 0, UGW 0+SPU instance 1, UGW 1+SPU instance 0, and UGW 1+SPU instance 1. Values of the indicators “2G+3G user quantity”, “4G user quantity”, “Gi interface packet quantity”, “SGi user-plane packet quantity”, and “quantity of user-plane packets received by a GW” of one device combination at peak time (for example, 17:00) of a day are used as a data sample, to obtain the first training data.

Four device combinations may be selected as data sources of the first training data, or three device combinations may be selected as data sources of the first training data. In at least one embodiment, four device combinations are selected.

Step 630: Determine whether diversity of the “user quantity” indicator in the first training data meets a preset condition.

If data diversity of the user quantity indicator in the first training data meets the preset condition, the first prediction model (also referred to as a “user quantity—traffic volume model”) may be established by performing step 640. If data diversity of the “user quantity” indicator in the first training data does not meet the preset condition, the first prediction model may be established by performing step 650.

Diversity of the indicator “2G+3G user quantity” and the indicator “4G user quantity” in the first training data may be determined.

Step 640: Perform constrained regression through the origin on the “user quantity” indicator and the “traffic volume” indicator in the first training data, to obtain a “user quantity—traffic volume model”.

If diversity of at least one of the user quantity indicators (the indicator “2G+3G user quantity” and the indicator “4G user quantity”) in the first training data does not meet the preset condition, constrained regression through the origin may be performed on the indicators “2G+3G user quantity”, “4G user quantity”, “Gi interface packet quantity”, “SGi user-plane packet quantity”, and “quantity of user-plane packets received by a GW” in the first training data, to obtain the “user quantity—traffic volume model” (the first prediction model).

For details about how to establish the first prediction model through regression, refer to the description of step 430 in FIG. 4. Details are not described herein again.

Step 650: Perform unconstrained regression through the origin on the user quantity indicator and the traffic volume indicator in the first training data, to obtain a “user quantity—traffic volume model”.

If diversity of the user quantity indicators (the indicator “2G+3G user quantity” and the indicator “4G user quantity”) in the first training data meets the preset condition, unconstrained regression through the origin may be performed on the indicators “2G+3G user quantity”, “4G user quantity”, “Gi interface packet quantity”, “SGi user-plane packet quantity”, and “quantity of user-plane packets received by a GW” in the first training data, to obtain the “user quantity—traffic volume model” (the first prediction model).

For details about how to establish the first prediction model through regression, refer to the description of step 430 in FIG. 4. Details are not described herein again.

Step 660: Obtain second training data based on the to-be-modeled device, where the second training data includes the “traffic volume” indicator and a “resource usage” indicator.

Step 660 corresponds to step 440 shown in FIG. 4. For details, refer to the description in FIG. 4. Details are not described herein again.

Step 670: Perform regression on the traffic volume indicator and the resource usage indicator in the second training data, to establish a second prediction model that describes a numerical relationship between the traffic volume indicator and the resource usage indicator.

Using the indicators “Gi interface packet quantity”, “SGi user-plane packet quantity”, and “quantity of user-plane packets received by a GW” of the UGW 0 and the SPU instance 0 (a target device) as the traffic volume indicators, and using the indicator “CPU peak usage” of the UGW 0 and the SPU instance 0 (the target device) as the resource usage indicator, regression is performed on the traffic volume indicators and the resource usage indicator, to obtain the second prediction model that describes the numerical relationship between the traffic volume indicator and the resource usage indicator.

In at least one embodiment, if a quantity of data sources for model training increases, and data diversity is still insufficient, a candidate solution may be provided to complete modeling, to meet an actual requirement.

In some embodiments, in a process of establishing the first prediction model by performing regression through the origin on the first indicator data and the second indicator data that are in both the first training data and the second training data, feature processing may be further performed on the second indicator data in both the first training data and the second training data. If input values of the second indicator data for feature processing are all zeros or approximately all zeros, output values of the second indicator data for feature processing are all zeros or approximately all zeros. Regression through the origin may be performed on feature-processed second indicator data and the first indicator data, to obtain the first prediction model through training. Regression through the origin may be performed on third indicator data and feature-processed second indicator data, to establish the second prediction model.

In at least one embodiment, in a process of performing feature processing on the second indicator data, all input values for feature processing that are all zeros or approximately all zeros may be mapped as output values for feature processing that are all zeros or approximately all zeros, to cooperate with constrained regression through the origin that is performed on the first training data.

A method for performing feature processing on the second indicator data in both the first training data and the second training data is not specifically limited in at least one embodiment. In an example, dimension reduction processing may be performed on the second indicator data in both the first training data and the second training data. For example, principal component analysis may be performed on the second indicator data. In another example, standardization processing may be performed on the second indicator data in both the first training data and the second training data. In another example, normalization processing may be performed on the second indicator data in the first training data and the second training data.

In at least one embodiment, constrained regression through the origin is performed on the user quantity indicator and the service usage indicator, so that model extrapolation is inaccurate due to insufficient diversity of the first indicator data in a dataset is avoided.

In some embodiments, dimension reduction processing may be performed on the second indicator data in both the first training data and the second training data.

In at least one embodiment, high-dimensional data may be mapped as low-dimensional data by performing dimension reduction processing, so that data redundancy is reduced. This may be considered as feature processing. Principal component analysis is a common dimension reduction processing method.

An implementation of performing dimension reduction processing on the second indicator data in both the first training data and the second training data is not specifically limited in at least one embodiment. In an example, principal component analysis may be performed on the second indicator data in both the first training data and the second training data, so that a principal component of the second indicator data can be obtained.

In at least one embodiment, principal component analysis may be performed on the second indicator data in the first training data, to obtain a principal component analysis model; dimension reduction processing may be performed on the first training data based on the obtained principal component analysis model, to obtain dimension-reduced third training data; and the first prediction model may be trained based on the obtained third training data.

In at least one embodiment, in an example, the second indicator data on which principal component analysis is performed may be an original value of the second indicator data. In another example, the second indicator data on which principal component analysis is performed may be a value obtained by performing standardization on the original value of the second indicator data. In another example, the second indicator data on which principal component analysis is performed may be a value obtained by performing normalization on the original value of the second indicator data.

In at least one embodiment, dimension reduction is performed on the second indicator data, to avoid calculation difficulty that is caused due to collinearity of the second indicator data and that may be encountered when regression is performed on the second training data.

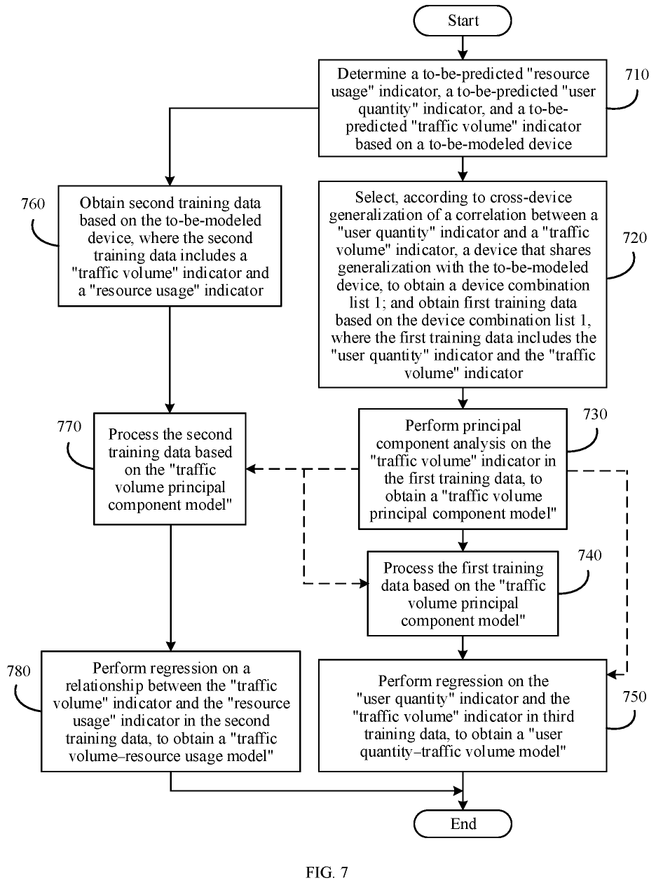

In some embodiments, based on FIG. 4, principal component analysis may be performed on the second indicator data in the first training data, to implement dimension reduction for the second indicator data in the first training data. The following describes this implementation in detail with reference to FIG. 7.

In at least one embodiment, performing principal component analysis on data is an implementation of performing dimension reduction processing on data. This is not specifically limited in.

Principal component analysis is performed on historical data of the second indicator data in the first training data, so that the principal component model of the second indicator data may be obtained.

In some embodiments, there may be a plurality of dimensions of output variables of the principal component model of the second indicator data, but a quantity of dimensions of the output variables may not be more than dimensions of input variables. In an example, there may be three dimensions for the second indicator data in at least one embodiment, and output principal components of the second indicator data may be fewer than three dimensions. For example, two dimensions: a principal component 1 for the second indicator data and a principal component 2 for the second indicator data, may be included.

In at least one embodiment, the principal component of the second indicator data mentioned above may be used to indicate a group of variables obtained by performing principal component analysis on the second indicator data. Principal component analysis may be a statistical method. A group of second indicator data that may have a correlation with each other may be converted into a group of linearly-unrelated variables through orthogonal transformation. The converted variables may be referred to as principal components of the second indicator data.

In some embodiments, an input variable for regression may not be an original value of the second indicator data, but a feature-processed value. For specific feature processing, refer to the foregoing description of feature processing. Details are not described herein again.

The following provides detailed descriptions by using an example in which the first indicator data is the user quantity, the second indicator data is the traffic volume, and the third indicator data is the resource usage.

FIG. 7 is a schematic flowchart of training a first prediction model and a second prediction model according to at least one embodiment. FIG. 7 includes step 710 to step 780. The following separately describes step 710 to step 780 in detail.

Step 710: Determine a to-be-predicted “resource usage” indicator, a to-be-predicted “user quantity” indicator, and a to-be-predicted “traffic volume” indicator based on a to-be-modeled device.

As shown in FIG. 3, it is determined, based on information that the to-be-modeled user quantity indicators are an indicator “2G+3G user quantity” of a network element UGW and an indicator “4G user quantity” of the network element UGW and based on information that the to-be-modeled resource usage indicator is an indicator “CPU peak usage” of an SPU instance, that the traffic volume indicators are an indicator “Gi interface packet quantity” of the network element UGW, an indicator “SGi user-plane packet quantity” of the network element UGW, and an indicator “quantity of user-plane packets received by a GW” of the SPU instance.

Step 720: Select, according to cross-device generalization of a correlation between a “user quantity” indicator and a “traffic volume” indicator, a device that shares generalization with the to-be-modeled device, to obtain a device combination list 1; and obtain first training data based on the device combination list 1, where the first training data includes the “user quantity” indicator and the “traffic volume” indicator.

The method for obtaining first training data in step 720 corresponds to step 420 shown in FIG. 4. For details, refer to the description in FIG. 4. Details are not described herein again.

Step 730: Perform principal component analysis on the “traffic volume” indicator in the first training data, to obtain a “traffic volume principal component model”.

The traffic volume principal component model may be obtained by performing principal component analysis on the “traffic volume” indicator in the first training data, so that dimension reduction can be implemented for the “traffic volume” indicator.

The first training data of the network elements UGW 0 and UGW 1 may be obtained, where the first training data includes the indicators “2G+3G user quantity”, “4G user quantity”, “Gi interface packet quantity”, and “SGi user-plane packet quantity” of the network elements, and the indicator “quantity of user-plane packets received by a GW” of the SPU instance.

Principal component analysis may be performed on the “traffic volume” indicators (for example, the indicator “Gi interface packet quantity”, the indicator “SGi user-plane packet quantity”, and the indicator “quantity of user-plane packets received by a GW” of the SPU instance) in the first training data, so that the traffic volume principal component model can be obtained.

Step 740: Process the first training data based on the “traffic volume principal component model”.

Processing is performed on the indicators “Gi interface packet quantity”, “SGi user-plane packet quantity”, and “quantity of user-plane packets received by a GW” in the first training data based on the “traffic volume principal component model” obtained in step 730, to obtain third training data.

Data of the network elements UGW 0 and UGW 1 may be obtained, where the data includes the indicators “2G+3G user quantity”, “4G user quantity”, “Gi interface packet quantity”, and “SGi user-plane packet quantity” of the network elements, and the indicator “quantity of user-plane packets received by a GW” of the SPU instance. Assuming that filtering may be performed on the obtained data of the network elements UGW 0 and UGW 1, regression may be performed on data obtained after filtering, to obtain the third training data.

Step 750: Perform regression on the “user quantity” indicator and the “traffic volume” indicator in the third training data, to obtain a “user quantity—traffic volume model”.

Regression may be performed on the “user quantity” indicator and the “traffic volume” indicator in the third training data, so that the “user quantity—traffic volume model” (also referred to as the first prediction model) of the network elements UGW 0 and UGW 1. For example, filtering is performed by using a time point 17:00 of each day as a peak time point, and regression may be performed on the indicators “2G+3G user quantity”, “4G user quantity”, “Gi interface packet quantity”, “SGi user-plane packet quantity”, and “quantity of user-plane packets received by a GW” in the third training data obtained after filtering, so that the “user quantity—traffic volume model” (the first prediction model) of the network elements UGW 0 and UGW 1 may be obtained.

Step 760: Obtain second training data based on the to-be-modeled device, where the second training data includes the “traffic volume” indicator and a “resource usage” indicator.

It is determined, based on information that the traffic volume indicators are an indicator “Gi interface packet quantity” of the network element UGW, an indicator “SGi user-plane packet quantity” of the network element UGW, and an indicator “quantity of user-plane packets received by a GW” of the SPU instance and based on information that the resource usage indicator is an indicator “CPU peak usage” of the SPU instance, that data samples are from target devices: the UGW 0 and the SPU instance 0. Values of the indicators “Gi interface packet quantity”, “SGi user-plane packet quantity”, “quantity of user-plane packets received by a GW”, and “CPU peak usage” of the device at any time point of a day are used as a data sample, to obtain the second training data.

Alternatively, the second training data may be selected from another device combination such as UGW 0+SPU instance 1. In at least one embodiment, the device combination UGW 0+SPU instance 0 is selected.

Step 770: Process the second training data based on the “traffic volume principal component model”.

In the second training data, feature processing is performed on the indicators “Gi interface packet quantity”, “SGi user-plane packet quantity”, and “quantity of user-plane packets received by a GW” based on the “traffic volume principal component model” established in step 730, to obtain the traffic volume indicator.

Step 780: Perform regression on the “traffic volume” indicator and the “resource usage” indicator in the second training data, to obtain a “traffic volume-resource usage model”.

Using the indicators “Gi interface packet quantity”, “SGi user-plane packet quantity”, and “quantity of user-plane packets received by a GW” of the UGW 0 and the SPU instance 0 (the target devices) as the traffic volume indicators, and using the indicator “CPU peak usage” of the UGW 0 and the SPU instance 0 (the target devices) as the resource usage indicator, regression is performed on the traffic volume indicator and the resource usage indicator, to obtain the “traffic volume-resource usage model” (the second prediction model).

In at least one embodiment, dashed arrows in FIG. 7 may be used to indicate indirect impact that is made on execution of another step. For example, a dashed arrow between step 730 and step 770 may be used to indicate an indirect impact that is made on execution of step 770 by the traffic principal component model established in step 730.

In at least one embodiment, principal component analysis may be performed on the second indicator data, and variation may be performed on the second indicator data to obtain principal components that are independent of each other, so that calculation difficulty due to traffic collinearity can be avoided.

In some embodiments, a model obtained through principal component analysis describes mapping. A point in an original space may correspond to a point in a mapping space, and the original in the original space is not necessary the original in the mapping space. The origin in the original space may be translated to the origin in the mapping space.

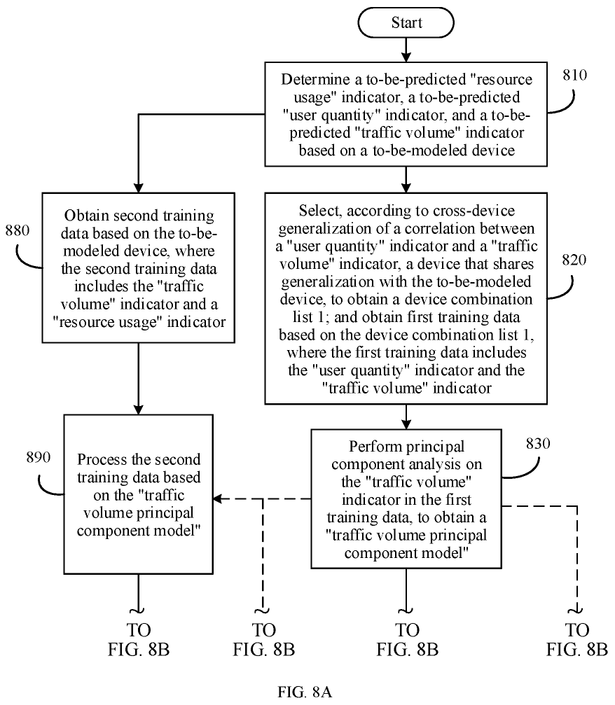

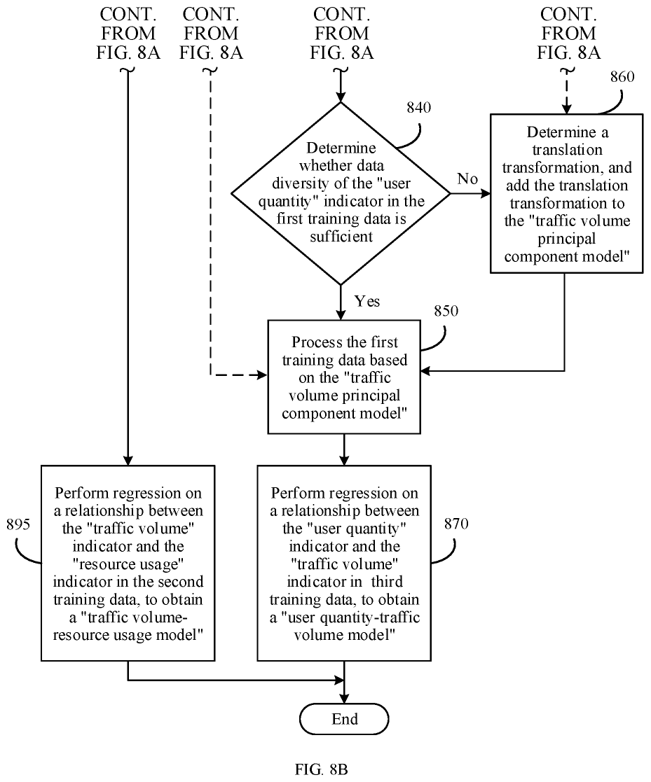

In some embodiments, determining of diversity of the first indicator data may be added based on FIG. 7. If data diversity of the first indicator data in the first training data meets the foregoing preset condition, regression through the origin may be performed on the first indicator data and the second indicator data in the first training data. If data diversity of the first indicator data in the first training data does not meet the foregoing preset condition, regression not through the origin may be performed on the first indicator data and the second indicator data in the first training data. The following describes this implementation in detail with reference to FIG. 8A and FIG. 8B.

In at least one embodiment, based on FIG. 7 (performing principal component analysis on the second indicator data in both the first training data and the second training data), determining of diversity of the first indicator data may be added. In an example, if diversity of the first indicator data meets the preset condition, unconstrained regression through the origin may be performed on the first indicator data and the second indicator data (the traffic volume principal component). In another example, if diversity of the first indicator data does not meet the preset condition, constrained regression through the origin may be performed on the first indicator data and the second indicator data (the traffic volume principal component). In the process of performing constrained regression through the origin, after principal component analysis is performed on the second indicator data, the origin in the original space is not necessarily the origin in the mapping space. The origin in the original space may be translated to the origin in the mapping space, so that constrained regression through the origin may be performed on the first indicator data and the second indicator data (the traffic volume principal component).

The following provides detailed descriptions by using an example in which the first indicator data is the user quantity, the second indicator data is the traffic volume, and the third indicator data is the resource usage.

FIG. 8A and FIG. 8B are a schematic flowchart of training a first prediction model and a second prediction model according to at least one embodiment. FIG. 8A and FIG. 8B include step 810 to step 890. The following separately describes step 810 to step 890 in detail.

Step 810: Determine a to-be-predicted “resource usage” indicator, a to-be-predicted “user quantity” indicator, and a to-be-predicted “traffic volume” indicator based on a to-be-modeled device.

As shown in FIG. 3, it is determined, based on information that the to-be-modeled user quantity indicators are an indicator “2G+3G user quantity” of a network element UGW and an indicator “4G user quantity” of the network element UGW and based on information that the to-be-modeled resource usage indicator is an indicator “CPU peak usage” of an SPU instance, that traffic volume indicators are an indicator “Gi interface packet quantity” of the network element UGW, an indicator “SGi user-plane packet quantity” of the network element UGW, and an indicator “quantity of user-plane packets received by a GW” of the SPU instance.

Step 820: Select, according to cross-device generalization of a correlation between a “user quantity” indicator and a “traffic volume” indicator, a device that shares generalization with the to-be-modeled device, to obtain a device combination list 1; and obtain first training data based on the device combination list 1, where the first training data includes the “user quantity” indicator and the “traffic volume” indicator.

Step 820 corresponds to step 720 shown in FIG. 7. For details, refer to the description in FIG. 7. Details are not described herein again.

Step 830: Perform principal component analysis on the “user quantity” indicator and the “traffic volume” indicator in the first training data, to obtain a “traffic volume principal component model”.

Step 830 corresponds to step 730 shown in FIG. 7. For details, refer to the description in FIG. 7. Details are not described herein again.

Step 840: Determine whether data diversity of the “user quantity” indicator in the first training data is sufficient.

Diversity of the user quantity indicator in the first training data may be determined. If data diversity of the user quantity indicator in the first training data meets a preset condition, step 850 may be performed. If data diversity of the user quantity indicator in the first training data does not meet the preset condition, step 860 may be performed before step 850.

Step 850: Process the first training data based on the “traffic volume principal component model”.

If data diversity of the user quantity indicator in the first training data meets the preset condition, feature processing is performed on the indicators “Gi interface packet quantity”, “SGi user-plane packet quantity”, and “quantity of user-plane packets received by a GW” in the first training data based on the traffic volume principal component model established in step 830, to obtain third training data.

Step 860: Determine a translation transformation, and add the translation transformation to the “traffic volume principal component model”.

If data diversity of the user quantity indicator in the first training data meets the preset condition, constrained regression through the origin needs to be performed on the user quantity indicator and the traffic volume indicator (the traffic volume principal component) in the first training data. A point in an original space may correspond to a point in a mapping space by using a model obtained though principal component analysis, and the original in the original space is not necessary the original in the mapping space. If input values for traffic volume indicator processing in the first training data and the second training data are all zeros or approximately all zeros, and output values for traffic volume indicator processing are not all zeros or approximately all zeros, a translation transformation T may be determined based on the output values that are not all zeros or approximately all zeros, the output values that are not all zeros or approximately all zeros in the first training data and the second training data may be translated by the translation transformation T, so that the output values for the traffic volume indicator processing are all zeros or approximately all zeros.

Step 870: Perform regression on the “user quantity” indicator and the “traffic volume” indicator in the third training data, to obtain a “user quantity—traffic volume model”.

In the third training data, using the indicators “2G+3G user quantity” and “4G user quantity” as the user quantity indicators, regression is performed on the user quantity indicator and the traffic volume indicator, to obtain the first prediction model through training.

Step 880: Obtain second training data based on the to-be-modeled device, where the second training data includes the “traffic volume” indicator and a “resource usage” indicator.

Step 880 corresponds to step 760 shown in FIG. 7. For details, refer to the description in FIG. 7. Details are not described herein again.

Step 890: Process the second training data based on the “traffic volume principal component model”.

Step 890 corresponds to step 770 shown in FIG. 7. For details, refer to the description in FIG. 7. Details are not described herein again.

Step 895: Perform regression on the “traffic volume” indicator and the “resource usage” indicator in the second training data, to obtain a “traffic volume-resource usage model”.

In the second training data, using the indicator “CPU peak usage” as the resource usage indicator, regression is performed on the traffic volume indicator and the resource usage indicator, to obtain the “traffic volume-resource usage model” (the second prediction model) through training.

In at least one embodiment, dashed arrows in FIG. 8A and FIG. 8B may be used to indicate indirect impact that is made on execution of another step. For example, a dashed arrow between step 830 and step 860 may be used to indicate an indirect impact that is made on execution of step 860 by the traffic principal component model established in step 830. For another example, a dashed arrow between step 830 and step 890 may be used to indicate an indirect impact that is made on execution of step 890 by the traffic principal component model established in step 890.

In at least one embodiment, after principal component analysis is performed on the second indicator data to obtain a principal component of the second indicator data, if data diversity still cannot meet the preset condition, a translation transformation may be added, and regression not through the origin in a principal component space of the second indicator data may be converted into regression through the origin (the original in an original space corresponds to the original in a mapping space). This manner is characterized by simple calculation and easy implementation.

In some embodiments, in a process of performing regression through the origin on the first indicator data in the first training data to establish the first prediction model, feature processing may be further performed on the first indicator data in the first data. If input values for processing performed on the first indicator data are all zeros or approximately all zeros, and output values for processing of the first indicator data are all zeros or approximately all zeros, regression through the origin may be performed on the first indicator data and the second indicator data, to establish the first prediction model.

In at least one embodiment, during feature processing of obtaining the first indicator data, all input values for feature processing that are all zeros or approximately all zeros are mapped to all output values for feature processing that are all zeros or approximately all zeros, to cooperate with constrained regression through the origin performed on the first training data.

A method for performing feature processing on the first indicator data in the first training data is not specifically limited in at least one embodiment. In an example, dimension reduction processing may be performed on the first indicator data in the first training data. For example, principal component analysis may be performed on the first indicator data. In another example, standardization processing may be performed on the first indicator data in the first training data. In another example, normalization processing may be performed on the first indicator data in the first training data.

In some embodiments, in a process of performing regression through the origin on the first indicator data and the second indicator data to establish the first prediction model, if the input values for processing of the first indicator data are all zeros or approximately all zeros, and the output values for processing of the first indicator data are not all zeros or approximately all zeros, a translation transformation may be determined based on the output values that are not all zeros or approximately all zeros, and the translation transformation may be performed on the output values that are not all zeros or approximately all zeros, so that the output values for processing of the first indicator data are all zeros or approximately all zeros. Further, regression through the origin may be performed on the first indicator data and the second indicator data, to establish the first prediction model.

A method for performing feature processing on the first indicator data is not specifically limited in at least one embodiment. In an example, dimension reduction processing may be performed on the first indicator data. For example, principal component analysis may be performed on the first indicator data. In another example, standardization processing may be performed on the first indicator data. In another example, normalization processing may be performed on the first indicator data.

In at least one embodiment, in feature processing of obtaining the first indicator data, all input values for feature processing that are all zeros or approximately all zeros are mapped to as all output values for feature processing that are all zeros or approximately all zeros, so as to cooperate with constrained regression through the origin performed on the first training data. If feature processing does not meet a requirement foregoing preset condition, the translation transformation may be added to meet the requirement.

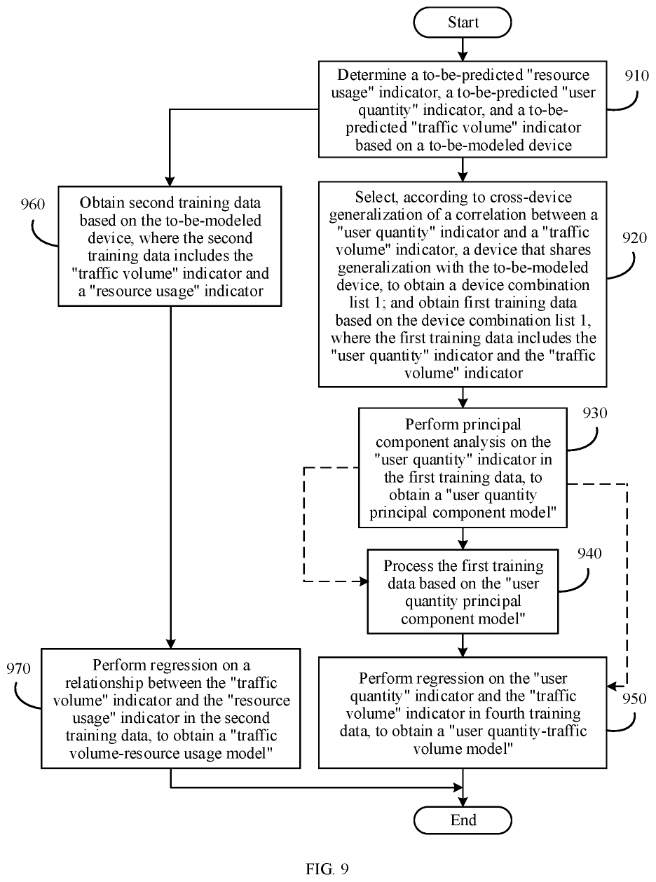

In some embodiments, based on FIG. 4, dimension reduction may be performed on the first indicator data in the first training data through principal component analysis, to obtain a dimension reduction feature of the first indicator data. The following describes this implementation in detail with reference to FIG. 9.

In at least one embodiment, in an example, the first indicator data on which principal component analysis is performed may be an original value of the first indicator data. In another example, the first indicator data on which principal component analysis is performed may be a value obtained by performing standardization on the original value of the first indicator data. In another example, the first indicator data on which principal component analysis is performed may be a value obtained by performing normalization on the original value of the first indicator data.

The following provides detailed descriptions by using an example in which the first indicator data is the user quantity, the second indicator data is the traffic volume, and the third indicator data is the resource usage.

FIG. 9 is a schematic flowchart of training a first prediction model and a second prediction model according to at least one embodiment. FIG. 9 includes step 910 to step 970. The following separately describes step 910 to step 970 in detail.

Step 910: Determine a to-be-predicted “resource usage” indicator, a to-be-predicted “user quantity” indicator, and a to-be-predicted “traffic volume” indicator based on a to-be-modeled device.

Step 910 corresponds to step 410 shown in FIG. 4. For details, refer to the description in FIG. 4. Details are not described herein again.

Step 920: Select, according to cross-device generalization of a correlation between a “user quantity” indicator and a “traffic volume” indicator, a device that shares generalization with the to-be-modeled device, to obtain a device combination list 1; and obtain first training data based on the device combination list 1, where the first training data includes the “user quantity” indicator and the “traffic volume” indicator.

Step 920 of obtaining the first training data corresponds to step 420 shown in FIG. 4. For details, refer to the description in FIG. 4. Details are not described herein again.

Step 930: Perform principal component analysis on the “user quantity” indicator in the first training data, to establish a “user quantity principal component model”.

The “user quantity principal component model” may be obtained by performing principal component analysis on the “user quantity” indicator in the first training data, so that dimension reduction can be implemented for the “user quantity” indicator.

Principal component analysis may be performed indicators “2G+3G user quantity” and “4G user quantity” in the first training data, to obtain the “user quantity principal component model”.

Step 940: Process the first training data based on the “user quantity principal component model”.

Processing is performed on the indicators “2G+3G user quantity” and “4G user quantity” in the first training data based on the “user quantity principal component model”, to obtain fourth training data.

Step 950: Perform regression on the “user quantity” indicator and the “traffic volume” indicator in the fourth training data, to obtain a “user quantity—traffic volume model”.

In the fourth training data, using indicators “Gi interface packet quantity”, “SGi user-plane packet quantity”, and “quantity of user-plane packets received by a GW” as the traffic volume indicators, and using a user quantity principal component feature as the user quantity indicator, regression is performed on the user quantity indicator and the traffic volume indicator, to obtain the “user quantity—traffic volume model” (the first prediction model).

Step 960: Obtain second training data based on the to-be-modeled device, where the second training data includes the “traffic volume” indicator and a “resource usage” indicator.

It is determined, based on information that the traffic volume indicators are an indicator “Gi interface packet quantity” of a network element UGW, an indicator “SGi user-plane packet quantity” of the network element UGW, and an indicator “quantity of user-plane packets received by a GW” of an SPU instance and based on information that the resource usage indicator is an indicator “CPU peak usage” of the SPU instance, that data samples are from target devices: the UGW 0 and the SPU instance 0. Values of the indicators “Gi interface packet quantity”, “SGi user-plane packet quantity”, “quantity of user-plane packets received by a GW”, and “CPU peak usage” of the device at any time point of a day are used as a data sample, to obtain the second training data.

Alternatively, the second training data may be selected from another device combination such as UGW 0+SPU instance 1. In at least one embodiment, the device combination UGW 0+SPU instance 0 is selected.

Step 970: Perform regression on the “traffic volume” indicator and the “resource usage” indicator in the second training data, to obtain the second prediction model.

In the second training data, using the indicator “CPU peak usage” as the resource usage indicator, regression is performed on the traffic volume indicator and the resource usage indicator, to obtain the second prediction model through training.

In at least one embodiment, principal component analysis may be performed on a first indicator data indicator, and principal components that are independent of each other may be obtained after variations are performed on the first indicator data indicator, to avoid a problem that it is difficult in calculation due to collinearity of the first indicator data indicator.

In some embodiments, principal component analysis may be performed on both the first indicator data indicator and the second indicator data.

In at least one embodiment, a principal component analysis may be performed on the first indicator data indicator based on FIG. 7 or FIG. 8A and FIG. 8B.

Optionally, at least one embodiment provides a prediction method, to obtain a predicted first indicator data indicator of a target device, and obtain a predicted third indicator data indicator based on a first prediction model and a second prediction model.

For methods for training the first prediction model and the second prediction model, refer to the foregoing methods for training the first prediction model and training the second prediction model. Details are not described herein again.

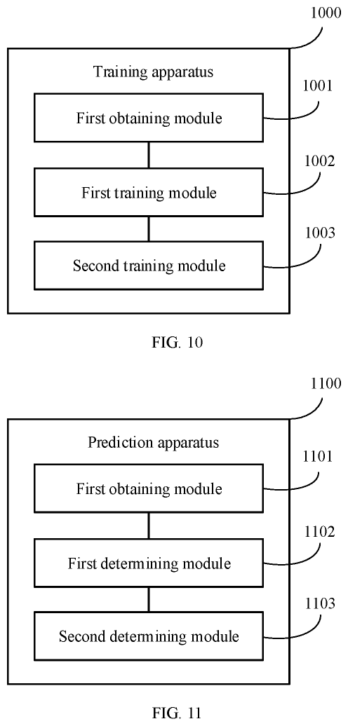

The foregoing describes the prediction method and the training method provided in some embodiments described in detail with reference to FIG. 1 to FIG. 9. The following describes an apparatus provided in some embodiments described in detail with reference to FIG. 10 to FIG. 13.

FIG. 10 is a schematic diagram of a training apparatus according to at least one embodiment. The training apparatus 1000 in FIG. 10 may perform the training method in any one of various embodiments in FIG. 1 to FIG. 9.

The training apparatus 1000 in FIG. 10 may include:

a first obtaining module 1001, configured to obtain first training data and second training data, where the first training data includes first indicator data and second indicator data that are of a plurality of devices, and the second training data includes second indicator data and third indicator data that are of a target device, where the target device is any one of the plurality of devices;

a first training module 1002, configured to obtain a first prediction model through training based on the first training data, where the first prediction model is used to predict the second indicator data of the target device based on the first indicator data of the target device; and a second training module 1003, configured to obtain a second prediction model through training based on the second training data, where the second prediction model is used to predict third indicator data of the target device based on the second indicator data that is of the target device and that is obtained based on the first prediction model.

In some embodiments, the first indicator data is a user quantity, the second indicator data is a traffic volume, and the third indicator data is a resource usage.

In some embodiments, the apparatus 1000 further includes:

a second obtaining module 1004, configured to obtain to-be-predicted first indicator data of the target device;

a first determining module 1005, configured to input the to-be-predicted first indicator data into the first prediction model, to obtain predicted second indicator data of the target device; and a second determining module 1006, configured to input the predicted second indicator data into the second prediction model, to obtain a prediction result of the target device.

The prediction model includes the first prediction model and the second prediction model. The first prediction model is obtained through training based on the first training data. The second prediction model is obtained through training based on the second training data.

In some embodiments, the first training module 1002 is specifically configured to: perform principal component analysis on the second indicator data in the first training data, to obtain a principal component analysis model; perform dimension reduction processing on the first training data based on the principal component analysis model, to obtain dimension-reduced third training data; and train the first prediction model based on the third training data.

In some embodiments, the first training module 1002 is specifically configured to perform regression on the first training data to obtain the first prediction model.

In some embodiments, the first training module 1002 is specifically configured to: when diversity of the first training data meets a preset condition, perform regression through the origin on the first training data; or when diversity of the first training data does not meet the preset condition, perform no regression not through the origin on the first training data.

In some embodiments, the second training module 1003 is specifically configured to perform regression on the second training data to obtain the second prediction model.

In some embodiments, the second training module 1003 is specifically configured to perform quantile regression on the second training data to obtain the second prediction model.

In some embodiments, the plurality of devices have a consistent indicator relationship between the first indicator data and the second indicator data.

FIG. 11 is a schematic diagram of a prediction apparatus according to at least one embodiment. The prediction apparatus 1100 in FIG. 11 may be configured to perform the prediction method in any one of the second aspect or the possible implementations of the second aspect. The prediction apparatus 1100 in FIG. 11 may include:

a first obtaining module 1101, configured to obtain to-be-predicted first indicator data of a target device;

a first determining module 1102, configured to input the to-be-predicted first indicator data into a first prediction model, to obtain predicted second indicator data of the target device; and

a second determining module 1103, configured to input the predicted second indicator data into a second prediction model, to obtain a prediction result of the target device.

The prediction models include a first prediction model and a second prediction model. The first prediction model is obtained through training based on first training data. The second prediction model is obtained through training based on second training data. The first training data includes first indicator data and second indicator data that are of a plurality of devices. The second training data includes the second indicator data and third indicator data that are of the target device. The plurality of devices include the target device.

In some embodiments, the first indicator data is a user quantity, the second indicator data is a traffic volume, and the third indicator data is a resource usage.

In some embodiments, the apparatus 1100 further includes:

a second obtaining module 1104, configured to obtain the first training data; and

a first training module 1105, configured to obtain the first prediction model through training based on the first training data, where

the first prediction model is used to predict the second indicator data of the target device based on the first indicator data of the target device.

In some embodiments, the first training module 1105 is specifically configured to:

perform principal component analysis on the second indicator data in the first training data, to obtain a principal component analysis model; perform dimension reduction processing on the first training data based on the principal component analysis model, to obtain dimension-reduced third training data; and train the first prediction model based on the third training data.

In some embodiments, the first training module 1105 is specifically configured to perform regression on the first training data to obtain the first prediction model.

In some embodiments, the first training module 1105 is specifically configured to: when diversity of the first training data meets a preset condition, perform regression through the origin on the first training data; or when diversity of the first training data does not meet the preset condition, perform regression not through the origin on the first training data.

In some embodiments, the apparatus 1100 further includes:

a third obtaining module 1106, configured to obtain the second training data; and

a second training module 1107, configured to obtain a second prediction model through training based on the second training data, where

the second prediction model is used to predict third indicator data of the target device based on the second indicator data that is of the target device and that is obtained based on the first prediction model.

In some embodiments, the second training module 1107 is specifically configured to perform regression on the second training data to obtain the second prediction model.

In some embodiments, the second training module 1107 is specifically configured to perform quantile regression on the second training data to obtain the second prediction model.

In some embodiments, the plurality of devices have a consistent indicator relationship between the first indicator data and the second indicator data.

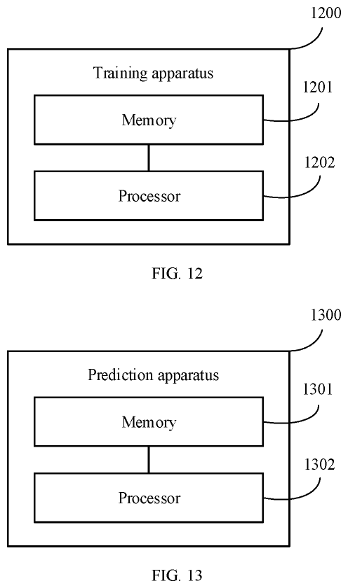

FIG. 12 is a schematic structural diagram of a training apparatus according to at least one embodiment. The training apparatus 1200 in FIG. 12 may perform the training method in any one of various embodiments in FIG. 1 to FIG. 9. The training apparatus 1200 in FIG. 12 may include a memory 1201 and a processor 1202. The memory 1201 may be configured to store a program, and the processor 1202 may be configured to execute the program stored in the memory. When the program stored in the memory 1201 is executed, the processor 1202 may be configured to perform the training method described in any one of the foregoing embodiments.

The processor 1202 may be a central processing unit (Central Processing Unit, CPU), a general-purpose processor, a digital signal processor (Digital Signal Processor, DSP), an application-specific integrated circuit (Application-Specific Integrated Circuit, ASIC), a field programmable gate array (Field Programmable Gate Array, FPGA), or another programmable logical device, a transistor logical device, a hardware component, or any combination thereof. The processor may implement or execute various example logical blocks, modules, and circuits described with reference to content disclosed in this application. Alternatively, the processor may be a combination of processors implementing a computing function, for example, a combination of one or more microprocessors, or a combination of the DSP and a microprocessor, and or the like.

Correspondingly, the memory 1201 may be configured to store program code and data of the apparatus for modeling a numerical relationship between a user quantity indicator and a resource usage indicator. Therefore, the memory 1201 may be a storage unit in the processor 1202, an external storage unit independent of the processor 1202, or a component including the storage unit in the processor 1202 and the external storage unit independent of the processor 1202.

FIG. 13 is a schematic structural diagram of a prediction apparatus according to at least one embodiment. The prediction apparatus 1300 in FIG. 13 may be configured to perform the prediction method in any one of the second aspect or the possible implementations of the second aspect. The prediction apparatus 1300 in FIG. 13 may include a memory 1301 and a processor 1302. The memory 1301 may be configured to store a program, and the processor 1302 may be configured to execute the program stored in the memory. When the program stored in the memory 1301 is executed, the processor 1302 may be configured to perform the training method described in any one of the foregoing embodiments.

The processor 1302 may be a central processing unit (Central Processing Unit, CPU), a general-purpose processor, a digital signal processor (Digital Signal Processor, DSP), an application-specific integrated circuit (Application-Specific Integrated Circuit, ASIC), a field programmable gate array (Field Programmable Gate Array, FPGA), or another programmable logical device, a transistor logical device, a hardware component, or any combination thereof. The processor may implement or execute various example logical blocks, modules, and circuits described with reference to content disclosed in this application. Alternatively, the processor may be a combination of processors implementing a computing function, for example, a combination of one or more microprocessors, or a combination of the DSP and a microprocessor, and or the like.

Correspondingly, the memory 1301 may be configured to store program code and data of the apparatus for modeling a numerical relationship between a user quantity indicator and a resource usage indicator. Therefore, the memory 1301 may be a storage unit in the processor 1302, an external storage unit independent of the processor 1302, or a component including the storage unit in the processor 1302 and the external storage unit independent of the processor 1302.

At least one At least one embodiment provides a non-transitory computer-readable storage medium, including a computer instruction. When the computer instruction is run on a training apparatus, the training apparatus is enabled to perform the training method in any one of the first aspect or the implementations of the first aspect.

At least one embodiment provides a non-transitory computer-readable storage medium, including a computer instruction. When the computer instruction is run on a prediction apparatus, the prediction apparatus is enabled to perform the prediction method in any one of the second aspect or the implementations of the second aspect.

At least one embodiment provides a chip, including a memory and a processor. The memory is configured to store a program, and the processor is configured to execute the program stored in the memory. When the program is executed, the processor performs the method in any one of the first aspect or the implementations of the first aspect.

At least one embodiment provides a chip, including a memory and a processor. The memory is configured to store a program, and the processor is configured to execute the program stored in the memory. When the program is executed, the processor performs the method in any one of the second aspect or the implementations of the second aspect.

At least one embodiment provides a computer program product. When the computer program product is run on a computer, the computer is enabled to perform the method in any one of the first aspect or the implementations of the first aspect.

At least one embodiment provides a computer program product. When the computer program product is run on a computer, the computer is enabled to perform the method in any one of the second aspect or the implementations of the second aspect.

The term “and/or” in some embodiments describes only an association relationship for describing associated objects and represents that three relationships may exist. For example, A and/or B may represent the following cases: Only A exists, both A and B exist, and only B exists. In addition, the character “/” in this specification generally indicates an “or” relationship between the associated objects.

All or some of the foregoing embodiments may be implemented by using software, hardware, firmware, or any combination thereof. When software is used to implement some embodiments, such embodiments may be implemented completely or partially in a form of a computer program product. The computer program product includes one or more computer instructions. When the computer program instructions are loaded and executed on a computer, the procedure or functions according to some embodiments of this application are all or partially generated. The computer may be a general-purpose computer, a dedicated computer, a computer network, or another programmable apparatus. The computer instructions may be stored in a computer-readable storage medium or may be transmitted from a computer-readable storage medium to another computer-readable storage medium. For example, the computer instructions may be transmitted from a website, computer, server, or data center to another website, computer, server, or data center in a wired (for example, a coaxial cable, an optical fiber, or a digital subscriber line (digital subscriber line, DSL)) or wireless (for example, infrared, radio, or microwave) manner. The computer-readable storage medium may be any usable, non-transitory medium accessible by a computer, or a data storage device, such as a server or a data center, integrating one or more usable media. The usable medium may be a magnetic medium (for example, a floppy disk, a hard disk, or a magnetic tape), an optical medium (for example, a digital video disc (digital video disc, DVD)), a semiconductor medium (for example, a solid state drive (solid state disk, SSD)), or the like.

A person of ordinary skill in the art may be aware that, in combination with the examples described in various embodiments disclosed in this specification, units and algorithm steps may be implemented by electronic hardware or a combination of computer software and electronic hardware. Whether the functions are performed by hardware or software depends on particular applications and design constraint conditions of the technical solutions. A person skilled in the art may use different methods to implement the described functions for each particular application, but it should not be considered that the implementation goes beyond the scope of this application.

It may be clearly understood by a person skilled in the art that, for the purpose of convenient and brief description, for a detailed working process of the foregoing system, apparatus, and unit, refer to a corresponding process in the foregoing method embodiments, and details are not described herein again.

In some embodiments, the disclosed system, apparatus, and method may be implemented in other manners. For example, the described apparatus in accordance with some embodiments is merely an example. For example, the unit division is merely logical function division and may be other division in actual implementation. For example, a plurality of units or components may be combined or integrated into another system, or some features may be ignored or not performed. In addition, the displayed or discussed mutual couplings or direct couplings or communication connections may be implemented through some interfaces. The indirect couplings or communication connections between the apparatuses or units may be implemented in electronic, mechanical, or other forms.

The units described as separate parts may or may not be physically separate, and parts displayed as units may or may not be physical units, may be located in one position, or may be distributed on a plurality of network units. Some or all of the units may be selected based on actual requirements to achieve the objectives of the solutions of various embodiments.

In addition, functional units in some embodiments may be integrated into one processing unit, or each of the units may exist alone physically, or two or more units are integrated into one unit.

When the functions are implemented in the form of a software functional unit and sold or used as an independent product, the functions may be stored in a computer-readable storage medium. Based on such an understanding, the technical solutions of some embodiments of this application, or a part of other approaches, or at least some of the technical solutions may be implemented in a form of a software product. The software product is stored in a storage medium, and includes several instructions for instructing a computer device (which may be a personal computer, a server, a network device, or the like) to perform all or some of the steps of the methods described in the embodiments of this application. The foregoing storage medium includes any medium that can store program code, such as a USB flash drive, a removable hard disk, a read-only memory (read-only memory, ROM), a random access memory (random access memory, RAM), a magnetic disk, or an optical disc.

The foregoing descriptions are merely specific implementations of this application, but are not intended to limit the protection scope of this application. Any variation or replacement readily figured out by a person skilled in the art within the technical scope disclosed in this application shall fall within the protection scope of this application. Therefore, the protection scope of this application shall be subject to the protection scope of the claims.

What is claimed is:

1. A method of modeling a numerical relationship between a user quantity indicator and a resource usage indicator, the method comprising:
performing first regression on a first dataset that describes a numerical relationship between a feature of the user quantity indicator and a feature of a service usage indicator, to obtain a first prediction model; and
performing second regression on a second dataset that describes a numerical relationship between the feature of the service usage indicator and a feature of the resource usage indicator, to obtain a second prediction model, wherein
any data sample in the first dataset corresponds to values of the user quantity indicator and values of the service usage indicator of a device combination under a condition; original values of the user quantity indicator of some devices in the device combination are directly used as the feature of the user quantity indicator in the data sample or are input for first feature processing, and an output value of the first feature processing is used as the feature of the user quantity indicator in the data sample; and original values of the service usage indicator of some devices in the device combination are directly used as the feature of the service usage indicator in the data sample or are input for second feature processing, and an output value of the second feature processing is used as the feature of the service usage indicator in the data sample;
in the first dataset, all data samples correspond to more than one device combination, there is at least one pair of data samples in the first dataset, and original values of the user quantity indicator in the pair of data samples are obtained from two different devices; and
any data sample in the second dataset corresponds to the values of the service usage indicator and values of the resource usage indicator of a device combination under a condition; original values of the service usage indicator of some devices in the device combination are directly used as the feature of the service usage indicator in the data sample or are input for the second feature processing, and an output value of the second feature processing is used as the feature of the service usage indicator in the data sample; and original values of the resource usage indicator of some devices in the device combination are directly used as the feature of the resource usage indicator in the data sample or are input for third feature processing, and an output value of the third feature processing is used as the feature of the resource usage indicator in the data sample.

2. The method according to claim 1, wherein the service usage indicator is determined based on the user quantity indicator and the resource usage indicator.

3. The method according to claim 1, wherein, in the first dataset, different data samples have similar load distribution relationships between a device that provides the original value of the user quantity indicator and a device that provides the original value of the service usage indicator.

4. The method according to claim 1, wherein, in the second feature processing, when input values are all zeros or approximately all zeros, output values are all zeros or approximately all zeros.

5. The method according to claim 4, wherein the second feature processing comprises a first translation transformation, and the first translation transformation is determined by:
performing partial processing of the second feature processing on the input values that are all zeros or approximately all zeros, and
determining the first translation transformation based on output values of the partial processing.

6. The method according to claim 1, wherein the first regression comprises:
performing constrained regression through an origin on the feature of the user quantity indicator and the feature of the service usage indicator in the first dataset.

7. The method according to claim 1, wherein the first regression comprises:
when diversity of the user quantity indicator in the first dataset does not meet a preset condition, performing constrained regression through an origin on the feature of the user quantity indicator and the feature of the service usage indicator in the first dataset, to obtain the first prediction model.

8. The method according to claim 1, wherein the first regression comprises:
when diversity of the user quantity indicator in the first dataset meets a preset condition, performing unconstrained regression through an origin on the feature of the user quantity indicator and the feature of the service usage indicator in the first dataset, to obtain the first prediction model.

9. The method according to claim 1, wherein the second feature processing comprises:
performing first dimension reduction mapping processing on some service usage indicators of a device in the first dataset, to obtain the feature of the service usage indicator.

10. The method according to claim 9, wherein the first dimension reduction mapping processing comprises:
performing feature processing based on a service usage principal component model,
wherein the service usage principal component model is determined by performing principal component analysis on a third dataset that describes a numerical relationship between features of some service usage indicators, to obtain the service usage principal component model.

11. The method according to claim 1, wherein, in the first feature processing, when input values are all zeros or approximately all zeros, output values are all zeros or approximately all zeros.

12. The method according to claim 11, wherein the first feature processing comprises a second translation transformation, and the second translation transformation is determined by:
performing partial processing of the first feature processing on the input values that are all zeros or approximately all zeros, and
determining the second translation transformation based on output values of the partial processing.

13. The method according to claim 1, wherein the first feature processing comprises:
performing second dimension reduction mapping processing on some user quantity indicators of a device in the first dataset, to obtain the feature of the user quantity indicator.

14. The method according to claim 13, wherein the second dimension reduction mapping processing comprises:
performing feature processing based on a user quantity principal component model,
wherein the user quantity principal component model is determined by performing principal component analysis on a fourth dataset that describes a numerical relationship between features of the user quantity indicator, to obtain the user quantity principal component model.

15. The method according to claim 1, further comprising:
obtaining to-be-predicted first indicator data of a target device;
inputting the to-be-predicted first indicator data into the first prediction model to obtain predicted second indicator data of the target device; and
inputting the predicted second indicator data into the second prediction model to obtain a predicted resource usage of the target device.

16. The method according to claim 15, further comprising:
in response to the predicted resource usage indicating that the target device is to be overloaded, pre-expanding the target device.

17. The method according to claim 16, wherein
the pre-expanding the target device is performed before carrying out an activity corresponding to the predicted resource usage.

18. The method according to claim 17, wherein
the target device comprises a network device.

19. An apparatus, comprising a processor configured to perform modeling a numerical relationship between a user quantity indicator and a resource usage indicator, by
performing first regression on a first dataset that describes a numerical relationship between a feature of the user quantity indicator and a feature of a service usage indicator, to obtain a first prediction model; and
performing second regression on a second dataset that describes a numerical relationship between the feature of the service usage indicator and a feature of the resource usage indicator, to obtain a second prediction model, wherein
any data sample in the first dataset corresponds to values of the user quantity indicator and values of the service usage indicator of a device combination under a condition; original values of the user quantity indicator of some devices in the device combination are directly used as the feature of the user quantity indicator in the data sample or are input for first feature processing, and an output value of the first feature processing is used as the feature of the user quantity indicator in the data sample; and original values of the service usage indicator of some devices in the device combination are directly used as the feature of the service usage indicator in the data sample or are input for second feature processing, and an output value of the second feature processing is used as the feature of the service usage indicator in the data sample;
in the first dataset, all data samples correspond to more than one device combination, there is at least one pair of data samples in the first dataset, and original values of the user quantity indicator in the pair of data samples are obtained from two different devices; and
any data sample in the second dataset corresponds to the values of the service usage indicator and values of the resource usage indicator of a device combination under a condition; original values of the service usage indicator of some devices in the device combination are directly used as the feature of the service usage indicator in the data sample or are input for the second feature processing, and an output value of the second feature processing is used as the feature of the service usage indicator in the data sample; and original values of the resource usage indicator of some devices in the device combination are directly used as the feature of the resource usage indicator in the data sample or are input for third feature processing, and an output value of the third feature processing is used as the feature of the resource usage indicator in the data sample.

20. A non-transitory computer readable medium comprising therein instructions for causing, when executed by a processor, the processor to perform modeling a numerical relationship between a user quantity indicator and a resource usage indicator, by
performing first regression on a first dataset that describes a numerical relationship between a feature of the user quantity indicator and a feature of a service usage indicator, to obtain a first prediction model; and
performing second regression on a second dataset that describes a numerical relationship between the feature of the service usage indicator and a feature of the resource usage indicator, to obtain a second prediction model, wherein
any data sample in the first dataset corresponds to values of the user quantity indicator and values of the service usage indicator of a device combination under a condition; original values of the user quantity indicator of some devices in the device combination are directly used as the feature of the user quantity indicator in the data sample or are input for first feature processing, and an output value of the first feature processing is used as the feature of the user quantity indicator in the data sample; and original values of the service usage indicator of some devices in the device combination are directly used as the feature of the service usage indicator in the data sample or are input for second feature processing, and an output value of the second feature processing is used as the feature of the service usage indicator in the data sample;
in the first dataset, all data samples correspond to more than one device combination, there is at least one pair of data samples in the first dataset, and original values of the user quantity indicator in the pair of data samples are obtained from two different devices; and
any data sample in the second dataset corresponds to the values of the service usage indicator and values of the resource usage indicator of a device combination under a condition; original values of the service usage indicator of some devices in the device combination are directly used as the feature of the service usage indicator in the data sample or are input for the second feature processing, and an output value of the second feature processing is used as the feature of the service usage indicator in the data sample; and original values of the resource usage indicator of some devices in the device combination are directly used as the feature of the resource usage indicator in the data sample or are input for third feature processing, and an output value of the third feature processing is used as the feature of the resource usage indicator in the data sample.
